(19) United States
(12) Patent Application Publication
(10) Pub. No.: US 2004/0070575 A1
(43) Pub. Date: Apr. 15, 2004

(54) Plasma display panel, and method and device for life test of the plasma display panel

(76) Inventors: Kazuhiko Sugimoto, Ibaraki-shi (JP); Kazuyuki Hasegawa, Kadoma-shi (JP); Hideaki Yasui, Hirakata-shi (JP); Hiroyoshi Tanaka, Kyoto-shi (JP); Koji Aoto, Nishinomiya-shi (JP); Hiroki Kono, Suita-shi (JP); Tadakazu Hayashi, Nagokakyo-shi (JP); Hajime Ikejima, Matsubara-shi (JP); Yoshinao Ooe, Kyoto-shi (JP); Masaaki Yamauchi, Takatsuki-shi (JP)

Correspondence Address: SNELL & WILMER LLP, 1920 MAIN STREET, SUITE 1200, IRVINE, CA, 92614-7230, US

(21) Appl. No.: 10/398,691

(22) PCT Filed: Oct. 10, 2001
(86) PCT No.: PCT/JP01/08897

(30) Foreign Application Priority Data
Oct. 12, 2000 (JP) 2000-312090
Oct. 12, 2000 (JP) 2000-312091
Oct. 12, 2000 (JP) 2000-312092

(51) Int. Cl. G09G 3/28

(52) U.S. Cl. 345/204; 345/60

(57) ABSTRACT

The object of the present invention is to provide a plasma display panel that contributes to reduction of loss costs by reducing the number of plasma display panels that need to be disposed of after performance evaluation tests. In order to achieve the object, the plasma display panel of the present invention comprises a front glass substrate and a rear glass substrate opposing each other, an image display cell field and an evaluation cell field that are both provided between the front and the rear glass substrates and are each sealed with an airtight sealing layer independently of the other cell field. Performance evaluation tests of the plasma display panel are performed by driving the evaluation cell field.

### TECHNICAL FIELD

The present invention relates to plasma display panels used for image display in computers, televisions, and the like, particularly to a life test method and a life test apparatus that are used to evaluate the life spans of the plasma display panels by having them deteriorate, and to plasma display panels suitable for performance evaluation through such life tests.

### BACKGROUND ART

In recent years, among different kinds of display devices used for image display in computers, televisions, and the like, Plasma Display Panels (hereafter referred to as PDPs) are noted for their possibility of providing large, thin, and light-weight display devices.

FIG. 16 is a planar view of a typical PDP 100, from which a front glass substrate 101 is removed. FIG. 17 is a perspective sectional view of a part of the image display field 123 of the PDP 100 in FIG. 16.

In the PDP 100, light emitting cells for different colors are arranged in a matrix configuration, and the front glass substrate 101 and the rear glass substrate 102 are disposed opposing each other and keeping a distance from each other with ribs 109 intervening therebetween, as shown in FIG. 17.

On the surface of the front glass substrate 101, pairs of discharge electrodes (display electrodes 103 and display scan electrodes 104) are disposed in parallel. On the surface of the rear glass substrate 102, address electrodes 107 are disposed in the manner that they orthogonally intersect the discharge electrodes. The glass substrates 101 and 102 are sealed with the airtight sealing layer 121 made of frit glass being shown with oblique lines in FIG. 16, all the way around inside the edges thereof. As a discharge space 122 is formed inside as shown in FIG. 17, inert gas is enclosed in the discharge space 122, and phosphor layers of red, green, blue (110R, 110G, and 110B) are provided. Ultraviolet rays, which are generated by sustain discharges between the display electrodes 103 and the display scan electrodes 104, excite the phosphor layers 110R, 110G, and 110B and cause them to emit light. Consequently, an image is displayed in the image display field 123 in FIG. 16.

Like any other display devices, there are demands that PDPs keep a good display quality for an extended length of time. It has been considered that, in order to use PDPs as part of general home appliances, they need to have a life span of more than tens of thousands of hours like CRTs which have been popularly used so far. There is however still lots of room for improvement with regard to life spans of PDPs at the moment.

Currently, there are research and development activities for improving life spans of PDPs. When evaluating life spans of PDPs, PDPs are deteriorated through a continuous drive lasting for more than a year (i.e. tens of thousands of hours) using the same method of driving as the one used to display normal images (hereafter referred to as normal operations) like in an actual use, which includes address periods and discharge sustain periods. And, we measure the length of time till the luminance decreases by 50 percent and check if a malfunction of discharge cells has occurred.

As regards the life tests for evaluating life spans of PDPS, there are demands for reducing the loss cost resulting from disposals of PDPs after the tests. Among PDPs manufactured through a same process, there maybe some PDPs that accidentally have short life spans because of inconsistency in products caused by errors during the manufacturing process. In order to monitor and prevent such short-life PDPs from getting on the market, one way to increase the possibility of finding them is to perform a sampling inspection on as many sample PDPs as possible and check their life spans by watching for luminance decrease and malfunctions of discharge cells during a continuous drive.

It is, however, difficult in terms of costs to perform life tests on so many PDP samples, because the product cost per panel is very high. PDP samples that have been continuously used through life tests need to be disposed of after the tests because their performance characteristics, for example luminance, are deteriorated to a considerable extent, and they have almost no value as products. Using too many PDPs for test samples will result in too high loss costs. Conversely, if the number of PDP samples used for life test sampling inspections are reduced in order to reduce the loss costs, the possibility of having short-life PDPs on the distribution market will increase.

There are also demands that life tests of PDPs take a shorter period of time. When it takes over a year to evaluate life spans of PDPs by continuously driving them, the speed of development activities for improving life spans of PDPs may be too slow sometimes.

In order to increase the speed of development activities, there is a driving method in which deterioration of PDPs are accelerated by making an all-white display with continuous sustain discharges throughout a frame without having any address discharges. Since deterioration of PDPs are usually caused by both address discharges and sustain discharges under the normal operation conditions, this driving method does not allow us to correctly evaluate life spans of PDPs reflecting the normal operation conditions where deterioration caused by address discharges is also taken into consideration. Thus, there are demands for a technique that reflects the normal operation conditions where deterioration caused by address discharges is taken into consideration, and also shortens the length of time taken for tests.

There are also demands for a technique that can be used to correctly evaluate life spans of PDPs under a condition similar to normal operation conditions, while the influence of impurity gases is taken into consideration.

When life tests are performed, it is preferable to continuously make an all-white display in the whole area of the image display field 123, because that allows all the phosphor layers of red, green, and blue to emit light. While doing so, however, there is a possibility of having what is called a panel crack—the heat from the continuous sustain discharges causes a thermal expansion of the front glass substrate 101 toward the direction shown with the arrow, and the stress concentration on the airtight sealing layer 121 results in a panel crack due to the difference in the thermal expansion coefficients between the front glass substrate 101 and the airtight sealing layer 121. In order to prevent such panel cracks caused by heat, a method used in life tests of the prior art is to change the light patterns in the image display field 123.

FIG. 18 shows an example of a light pattern in the image display field 123 used in life tests of the prior art.

As shown in FIG. 18, displayed in the image display field 123 is a light pattern made up of (i) the always-on area 701 at the central area of the image display field 123 and (ii) the always-off area 702 which is positioned at the whole perimeter area of the image display field 123 so as to surround the always-on area 701. Here, the always-on area denotes an area where a sustain discharge is generated in one frame without fail, and a white display is shown all the time. The always-off area denotes an area where no sustain discharge is generated throughout the driving time of the life tests, and no light is emitted. It should be also noted that life span evaluation is performed by measuring the luminance of the always-on area 701 and checking for malfunctions of the discharge cells in the always-on area 701.

Since the always-off area 702 does not generate heat during the life tests and is positioned at the whole perimeter area of the image display field 123, heat generation is inhibited at the perimeter area of the glass substrates 101 and 102. Consequently, it is possible to prevent panel cracks because the strain from the thermal expansion is reduced, and the stress concentration is mitigated near the airtight sealing layer 121. Alternatively, it is possible to prevent panel cracks in a similar fashion also when the always-on areas 711 and 721 are provided in a lattice pattern as shown in FIGS. 19 and 20, as long as at least the always-off areas 712 and 722 are provided in the perimeter area of the image display field 123.

It is however considered that, in the life tests of the prior art mentioned above, life spans of PDPs are not evaluated correctly under a condition similar to normal operation conditions, because behavior of impurity gases inside the panel that could influence the luminance deterioration of PDPs is not taken into account.

The reason could be explained as follows: normally, in the always-on area 701, impurities included in the phosphor layers and the like are gasified by the heat from sustain discharges and diffused into the discharge space, whereas in the always-off area 702, since there are no sustain discharges generated, the impurity gases are sequentially trapped and accumulated in the phosphor layers and the like in the area. When PDPs are used as display devices such as TVs in normal operations, there are hardly any always-off areas, and such behavior of impurity gases that they are trapped is not likely to occur.

In view of the problems so far mentioned, a first object of the present invention is to provide PDPs and a manufacturing method of PDPs that are effective in reducing the loss costs, even if a large quantity of PDPs are used in sampling inspections of life tests.

A second object of the present invention is to provide, in view of the normal operation conditions, a method and an apparatus for life tests that make it possible to accelerate deterioration of PDPs under similar conditions.

A third object of the present invention is to provide a method and an apparatus for life tests that make it possible to correctly evaluate life spans of PDPs under a condition similar to normal operation conditions in view of influence of impurity gases.

### DISCLOSURE OF THE INVENTION

In order to achieve the first object, the present invention provides a plasma display panel comprising: a first cell field that includes discharge cells arranged in a matrix and is for image display; and a second cell field that is provided in an area different from the first cell field, includes discharge cells arranged in a matrix, and is for performance evaluation.

With this arrangement, the first cell field can be still used as a product of an image display device even after the second cell field have been used for performance evaluations to find out life span characteristics and aging characteristics; therefore, it is not necessary to dispose of the panels after the performance evaluations, and it is possible to reduce loss costs.

Further, the plasma display panel may have an arrangement wherein the first cell field and the second cell field both include electrodes to which such a voltage is applied that enables all the discharge cells in the cell fields to emit light, and the first cell field and the second cell field are disposed inside discharge spaces that are independent of each other and sealed airtight.

With this arrangement, the impurities that have been generated during the performance evaluations with the second display field being used will not come into the first cell field.

In addition, the plasma display panel may have an arrangement wherein the electrodes in the first cell field are driven independently of the electrodes in the second cell field.

With this arrangement, since there is no image displayed in the first cell field, while the second cell field is used for performance evaluations, it is possible to use the first cell field as a product.

In addition, the plasma display panel may have an arrangement wherein discharge gas that is inert gas is enclosed in both of the discharge spaces, and the discharge space of the second cell field further has additional discharge gas enclosed therein that accelerates deterioration of the discharge cells in the second cell field.

With this arrangement, it is possible to shorten the period of time taken for evaluations of life span characteristics.

In order to accelerate deterioration of the cells, the plasma display panel may have an arrangement wherein the discharge gas enclosed in the discharge space of the second cell field (a) has a smaller mean molecular weight, or (b) is lower in pressure than the discharge gas enclosed in the discharge space of the first cell field.

The present invention also provides a life test method for a plasma display panel comprising: a first step of assembling the plasma display panel having (i) a first cell field that includes discharge cells arranged in a matrix and is for image display, and (ii) a second cell field that is provided in an area different from the first cell field, includes discharge cells arranged in a matrix, and is for evaluation of life span characteristics; and a second step of evaluating the life span characteristics by driving the second cell field using a predetermined driving method.

With this arrangement, it is possible to reduce the possibility of having short-life plasma display panels on the market as well as to reduce the loss costs.

Further, the life test method may have an arrangement wherein the predetermined driving method accelerates deterioration of the second cell field more than a driving method used to display images in the first cell field does.

With this arrangement, it is possible to evaluate life spans in a shorter period of time.

In order to achieve the second object, the present invention provides a life test method for a plasma display panel by which deterioration of the plasma display panel is accelerated, wherein the deterioration is accelerated while the plasma display panel is driven with use of an intraframe time-division gray-scale display method, and according to the intraframe time-division gray-scale display method used in the life test method, a time-division display pattern is made so that (i) a frame includes one or more address periods during each of which an address discharge is generated, (ii) a remainder of the frame besides the address periods includes one or more discharge sustain periods, and (iii) a total number of discharges during the one or more discharge sustain periods per frame is larger than that in another intraframe time-division gray-scale display method that is used for normal operations of plasma display panels.

With this arrangement, since the number of times of discharges per frame is larger than in the case of the image display drive mode, and deterioration of PDPs caused by the discharges is accelerated, it is possible to evaluate life spans of PDPs in a shorter period of time.

Further, the life test method may have an arrangement wherein according to the intraframe time-division gray-scale display method used in the life test method, during at least one of the discharge sustain periods, a cycle of a discharge sustain pulse is shorter than that in the other intraframe time-division gray-scale display method that is used for normal operations of plasma display panels. Alternatively, the life test method may have an arrangement wherein according to the intraframe time-division gray-scale display method used in the life test method, a total length of the address periods per frame is shorter than that in the other intraframe time-division gray-scale display method that is used for normal operations of plasma display panels. Additionally, it is also acceptable to combine both of these arrangements. With one or both of these arrangements, it is possible to increase the number of times of discharges being generated, and to accelerate deterioration of the PDPs caused by those discharges.

Additionally, in order to have the latter arrangement above, the life test method may specifically have an arrangement wherein (a) according to the intraframe time-division gray-scale display method used in the life test method, a total number of the address periods per frame is smaller than that in the other intraframe time-division gray-scale display method that is used for normal operations of plasma display panels, or (b) according to the intraframe time-division gray-scale display method used in the life test method, the address discharges are generated concurrently on two or more electrodes among electrodes disposed on the plasma display panel.

This way, since the length of the address period per frame becomes shorter, it is possible to make the length of the discharge sustain periods per frame longer and generate a larger number of times of discharges.

The present invention further provides a life test method for a plasma display panel by which deterioration of the plasma display panel is accelerated, wherein the deterioration is accelerated while the plasma display panel is driven with use of an intraframe time-division gray-scale display method, and according to the intraframe time-division gray-scale display method used in the life test method, a time-division display pattern is made so that (i) a frame includes one or more address periods during each of which an address discharge is generated, (ii) a remainder of the frame besides the address periods includes one or more discharge sustain periods, and (iii) during at least one of the discharge sustain periods, a discharge sustain pulse is applied at a higher voltage level than in another intraframe time-division gray-scale display method that is used for normal operations of plasma display panels.

With this arrangement, deterioration of PDPs is accelerated because phenomena, such as ion collisions with cathode materials at times of discharges, are accelerated more than in the case of normal operations. Thus, it is possible to evaluate life spans of PDPs in a shorter period of time.

In order to achieve the third object, the present invention provides a life test method of a plasma display panel, wherein the plasma display panel is driven with use of an intraframe time-division gray-scale display method, an always-on image, in which lights are continuously on, is displayed in an image display field of the plasma display panel except for a perimeter area that is near and inside edges of the image display field, and a blinking image, in which lights are repeatedly turned off and on, is displayed in the perimeter area.

With this arrangement, it is possible to prevent panel cracks, because heat generation at the perimeter area is inhibited by having the blinking image displayed in the whole perimeter area of the image display field, and therefore stress concentration to the airtight sealing layer caused by thermal expansion of the glass substrates is mitigated. Moreover, in the rest of the image display field where the always-on image is not displayed, a blinking image is displayed; therefore, there is no always-off image in the image display field. In addition, in the area where the blinking image is displayed, impurity gases will not be trapped or accumulated at any part, unlike in the area where the always-on image is displayed. Thus, it is possible to evaluate life spans of PDPs while behavior of impurity gases inside PDPs are under a condition similar to normal operation conditions.

Further, the life test method may have an arrangement wherein the blinking image is an image in which an area where lights are on cyclically scrolls in a predetermined direction, the area being in a shape of a band and having a predetermined width.

Moreover, it is preferable if the life test method has an arrangement wherein in the blinking image, the lights in the band-shaped area are on for at least ten percent of a time length of one cycle of blinking. It is because most of the impurities trapped in the phosphor layers get gasified, and life spans of PDPs will be evaluated more correctly.

The present invention further provides a life test method for a plasma display panel, wherein the plasma display panel is driven with use of an intraframe time-division gray-scale display method, a high gray-scale level image, in which light is emitted at a high gray-scale level, is displayed in an image display field of the plasma display panel except for a perimeter area that is near and inside edges of the image display field, and a low gray-scale level image, in which light is emitted at a low gray-scale level, is displayed in the perimeter area.

With this arrangement, it is possible to evaluate the life span of the PDP at the area where a high gray-scale level image is displayed, and also to prevent panel cracks because heat generation at the perimeter area is inhibited by having a low gray-scale level image displayed in the whole perimeter area of the image display field. In addition, since there is no always-off image displayed in the image display field, impurity gases will not be trapped and accumulated at any part. Thus, it is possible to correctly evaluate the life span of the PDP under a condition similar to normal operation conditions where the influence of impurity gases is taken into consideration.

### BRIEF DESCRIPTION OF THE DRAWINGS

FIG. 1 is a block diagram of a PDP life test apparatus;

FIG. 2 is a planar view of the PDP of the first embodiment of the present invention, from which the front glass substrate is removed;

FIG. 3 is a perspective sectional view to show the structure of the evaluation cell field of the first embodiment of the present invention;

FIG. 4 shows a driving method for displaying a normal image on a PDP;

FIG. 5 shows the driving method of the PDP life test apparatus in the first embodiment of the present invention;

FIG. 6 shows the driving method of the PDP life test apparatus in the second embodiment of the present invention;

FIG. 7 shows the driving method of the PDP life test apparatus in the third embodiment of the present invention;

FIG. 8 shows the driving method of the PDP life test apparatus in the fourth embodiment of the present invention;

FIG. 9 is a block diagram for the PDP life test apparatus in the fifth embodiment of the present invention;

FIG. 10 shows an image display pattern of the PDP in the fifth embodiment of the present invention;

FIG. 11 shows an image display pattern of the PDP in the fifth embodiment of the present invention;

FIG. 12 shows an image display pattern of the PDP in the fifth embodiment of the present invention;

FIG. 13 shows an image display pattern of the PDP in the sixth embodiment of the present invention;

FIG. 14 shows an image display pattern of the PDP in the seventh embodiment of the present invention;

FIG. 15 is a schematic chart that shows the correlation between the voltages for all-lights on during an aging process and the length of the aging process period;

FIG. 16 is a planar view of a PDP of the prior art, from which the front glass substrate is removed;

FIG. 17 is a perspective sectional view to show the structure of a part of the image display field of a PDP;

FIG. 18 shows an image display pattern of the PDP of the prior art;

FIG. 19 shows an image display pattern of the PDP of the prior art; and

FIG. 20 shows an image display pattern of the PDP of the prior art.

### BEST MODE FOR CARRYING OUT THE INVENTION

First Embodiment

The following describes a PDP and a PDP life test apparatus to which the present invention is applied, with reference to the drawings.

General Structure of the PDP Life Test Apparatus 150

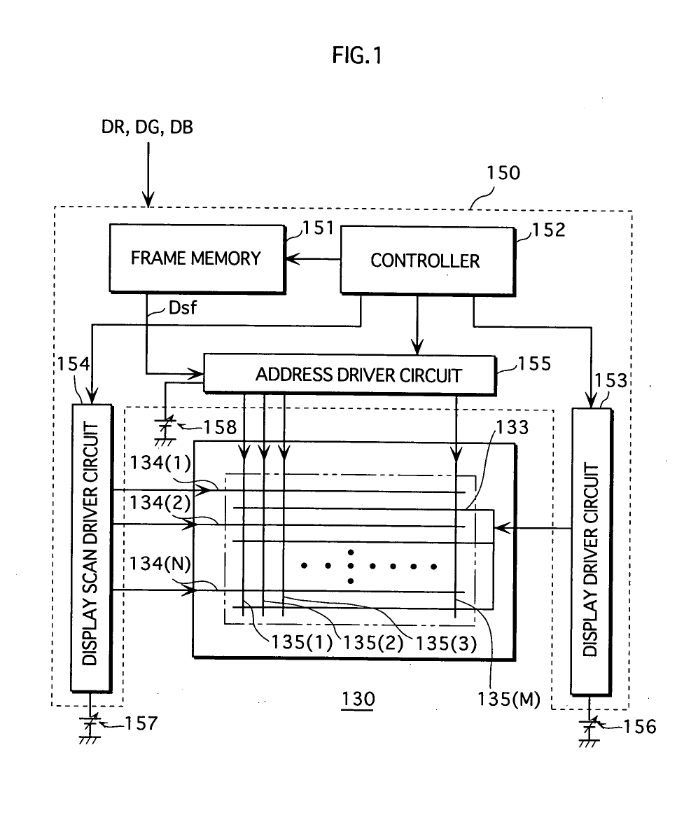

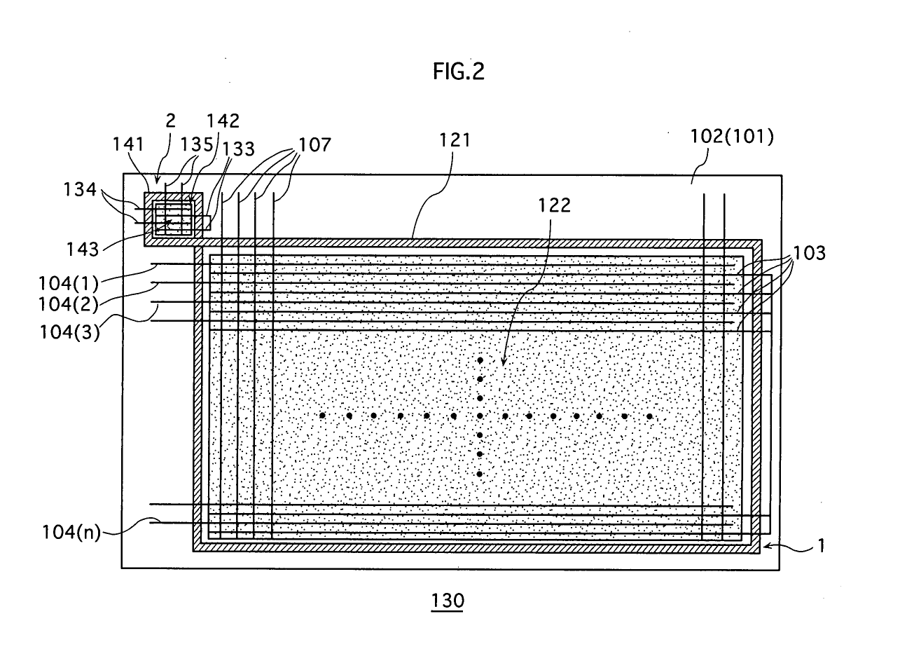

FIG. 1 is a circuit block diagram of the PDP life test apparatus 150 in the first embodiment of the present invention. It should be noted that the PDP 130 in FIG. 1 is to schematically illustrate only the evaluation cell field 2 of the PDP 130 shown in FIG. 2, and illustration of the image display cell field 1 is omitted.

As shown in FIG. 1, the PDP life test apparatus 150 comprises a frame memory 151 which stores image data DR, DG, DB and the like that have been inputted from an external image outputting apparatus and correspond to the colors of red (R), green (G), and blue (B) respectively; a controller 152 that controls the processing of the stored image data DR, DG, and DB and the driving of circuits; a display driver circuit 153 that applies a predetermined level of voltage to display electrodes 133 according to instructions from the controller 152; a display scan driver circuit 154 that applies a predetermined level of voltage to display scan electrodes 134; an address driver circuit 155 that applies a predetermined level of voltage to address electrodes 135; and variable voltage power supplies 156, 157, and 158 that supplies a predetermined level of voltage to the driver circuits 153, 154, 155. The PDP life test apparatus 150 is connected detachably to the evaluation cell field 2 of the PDP 130 (FIG. 2) which is to go through life tests.

The frame memory 151 stores, for each frame, image data divided into subframes. The frame memory 151 once stores, along with various synchronizing signals, multivalue image data DR, DG, and DB, indicating luminance levels (gray-scale levels) of red (R), green (G) and blue (B) in each pixel that have been inputted from the external apparatus. After having been stored in the frame memory 151, and further being read from the frame memory 151 by the controller 152, the image data DR, DG, and DB are converted, for the purpose of display with gray-scale levels, to another kind of image data (hereafter referred to as subframe data, Dsf) which is a group of binary data indicating either light-on or light-off of the cells, for each subframe and for each color, before being stored back in the frame memory 151 again.

The controller 152 drives the display driver circuit 153, the display scan driver circuit 154, the address driver circuit 155, using the driving method mentioned later, according to the subframe data Dsf.

Having variable voltage power supplies 156 and 157 attached thereto respectively, the display driver circuit 153 and the display scan driver circuit 154 are connected to display electrodes 133 and the display scan electrodes 134 (both explained later), and apply discharge sustain pulses of predetermined cycles and voltage levels to the display electrodes 133 and display scan electrodes 134 respectively, according to the signals transmitted from the controller 152.

The address driver circuit 155 has the variable voltage power supply 158 attached thereto which applies a voltage to this circuit, and it is also connected to the address electrodes 135 (explained later). The address driver circuit 155 applies a predetermined level of voltage to the address electrodes 135 according to the signals transmitted from the controller 152.

When the PDP 130 serves as a display device for a computer or a television, the image display cell field 1, which is to be explained later, will be connected to another driving apparatus having the same structure as the PDP life test apparatus 150, and images will be displayed there according to image data transmitted from a tuner. Thus, the PDP life test apparatus 150 has functions as a plasma display device.

Structure of PDP 130

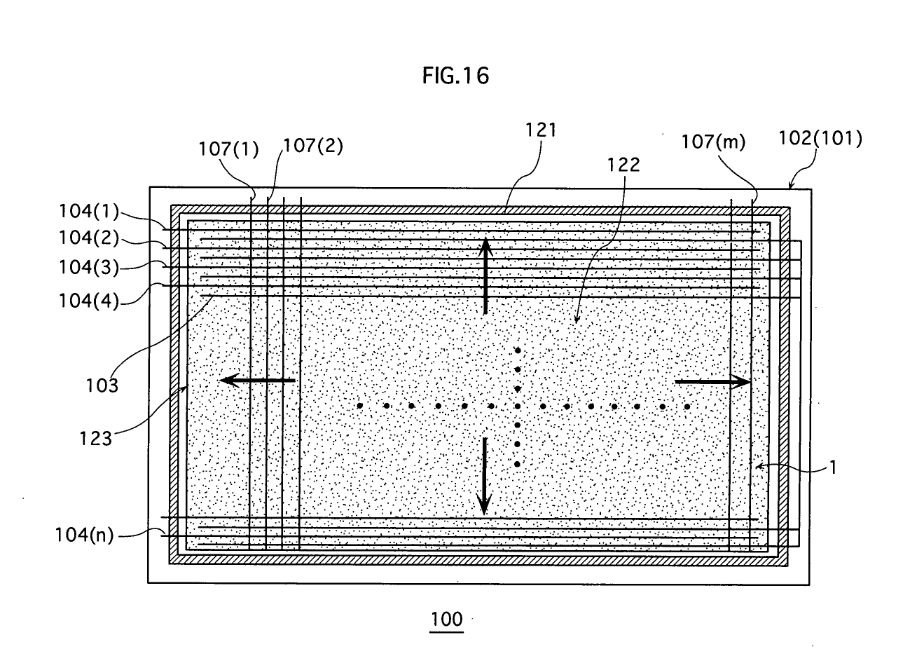

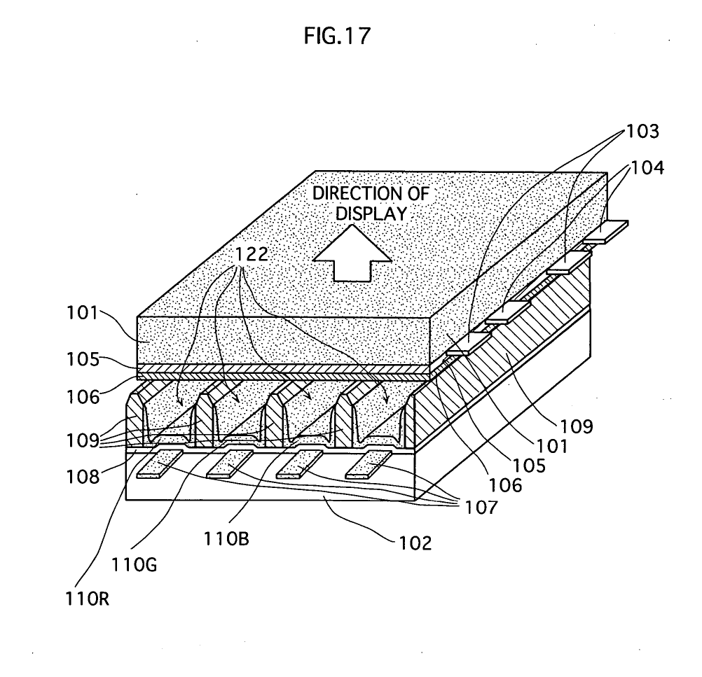

FIG. 2 is a schematic planar view of the PDP 130, being an example to which the present invention is applied, from which the front glass substrate 101 is removed. As for the display electrodes 103, 133, the display scan electrodes 104, 134, and the address electrodes 107, 135, not all of them are shown in the drawing to keep it simple. Also, explanation is omitted as to constituents that have the same numbers attached thereto as in the description of FIGS. 16 and 17, since those constituents are the same.

As shown in FIG. 2, the PDP 130 has the image display cell field 1 and the evaluation cell field 2, and basically has a similar structure to the PDP 100 explained as the prior art, with reference to FIGS. 16 and 17, but differs in that it includes the evaluation cell field 2 to be used for life tests, being positioned adjacent to an end of the image display cell field 1.

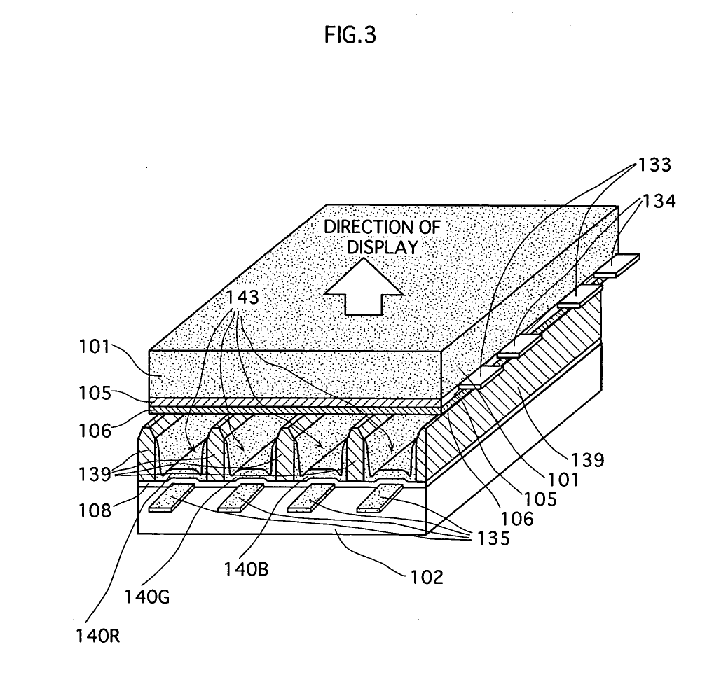

The evaluation cell field 2 has a similar structure to the image display cell field 1, except for its area size being smaller than the image display cell field 1. The evaluation cell field 2 comprises display electrodes 133, display scan electrodes 134, and address electrodes 135 all provided between the front glass substrate 101 (FIG. 3) and the rear glass substrate 102 opposing each other and is sealed by an airtight sealing layer 141.

Here, as for the evaluation cell field 2, the area size of the display field 142 (the dotted area) where displays using light emission are available can be as small as what is needed for evaluation of the life span (about 10 cells). It means that the area size of the display field 142 may be changed according to the size of the light-receiving area of a luminance tester or the like that is used for evaluating the life span of the PDP. This way, the area size can be minimum, and the material used can be reduced; therefore, it is preferable cost-wise. Also, it is acceptable if the evaluation cell field 2 has the same size as the image display cell field 1.

FIG. 3 is a perspective sectional view to show the structure of the evaluation cell field 2.

As shown in FIG. 3, on the opposing surface of the front glass substrate 101, N pieces of display electrodes 133 and N pieces of display scan electrodes 134 are provided alternately in stripes, extending in parallel (In FIG. 3, only two pieces of each kind of electrodes are shown. Hereafter, an electrode in the N'th line will be indicated by an attached character, as shown in FIG. 1.) The display electrodes 133 and the display scan electrodes 134 are made up of (i) transparent electrodes and (ii) bus electrodes which prevent a voltage decrease caused by electrical resistance of the transparent electrodes (neither of the electrodes is shown in the drawing). Also, the display electrodes 133 and the display scan electrodes 134 are covered with a dielectric layer 105 made of lead glass and the like, and are further covered with an MgO protective layer 106.

On the opposing surface of the rear glass substrate 102, M pieces of address electrodes 135 (cf. FIG. 1. In FIG. 3, only four pieces are shown. Hereafter, an electrode in the M'th line will be indicated by an attached character.) are provided in stripes and in the direction orthogonal to that of the display electrodes 133 and the display scan electrodes 134, and are covered with a dielectric layer 108 made of lead glass and the like.

Ribs 139 are formed along and between the address electrodes 135. These ribs 139 are for preventing a discharge from spreading to an adjacent cell at times of address discharges, and preventing what is called light cross talk. Each of the areas between two adjacent ribs 139 are individually coated with one of phosphor materials 140R, 140G, and 140B which are to emit light in colors of red (R), green (G) and blue (B), and the address electrodes 135 are each covered with these phosphor materials as well. Although the ribs are provided in stripes in the first embodiment, it should be noted that the ribs may be provided in other formations such as a lattice pattern.

A discharge space 143 is formed between the front glass substrate 101 and the rear glass substrate 102, and the airtight sealing layer 141 seals the gap between the glass substrates 101 and 102 so as to form the evaluation cell field 2, as shown in FIG. 2.

This way, the discharge space 143 of the evaluation cell field 2 is independent of the discharge space 122 of the image display cell field 1. The electrodes provided are also able to drive each of the cell fields independently. Thus, it is possible to perform life tests selectively on the evaluation cell field 2, and even if impurities included in the cathode materials, ribs, and phosphor materials are released into the discharge space 143 in the form of impurity gases due to ion collisions etc. at times of discharges, there is no possibility that such impurity gases go into the discharge space 122.

Consequently, the image display cell field 1 of the PDP 130 is able to serve as a product without any problem after life tests have been performed, and it is not necessary to dispose of PDPs that have been used in life tests; therefore, it is possible to reduce loss costs down to less than those of the prior art.

Enclosed in the discharge space 143 is the same gas having the same pressure (normally, approx. 6.5×10⁴ to 10×10⁴ Pa) as the discharge gas that is enclosed in the discharge space 122 of the image display cell field 1, the discharge gas including neon as the main constituent and also a small amount of xenon as a buffer gas. If the gas enclosed in the evaluation cell field 2 is lower in pressure than the discharge gas enclosed in the image display cell field 1, ion collisions with the cathode materials are more likely to occur, and deterioration of the PDP is accelerated. Thus, it is possible to evaluate the life span in a shorter period of time. Furthermore, instead of xenon, if helium, having a smaller mass number, is included in the discharge gas as a buffer gas so that the mean molecular weight of the discharge gas becomes smaller, then ion collisions with the cathode materials are more likely to occur, and deterioration of the PDP is accelerated. Thus, it is possible to evaluate the life span in a shorter period of time.

Driving Method of PDP 130

(1) Driving Method of the Image Display Cell Field 1

Firstly, a driving method for displaying normal images in the image display cell field 1 when the PDP 130 is used as a product will be explained.

Generally speaking, as a method for displaying with multi gray-scale levels in a PDP, “the intraframe time-division gray-scale display method” is used, in which one frame is divided into a plurality of subframes and intermediate gray-scale levels are expressed in combinations of light-on and light-off in each subframes.

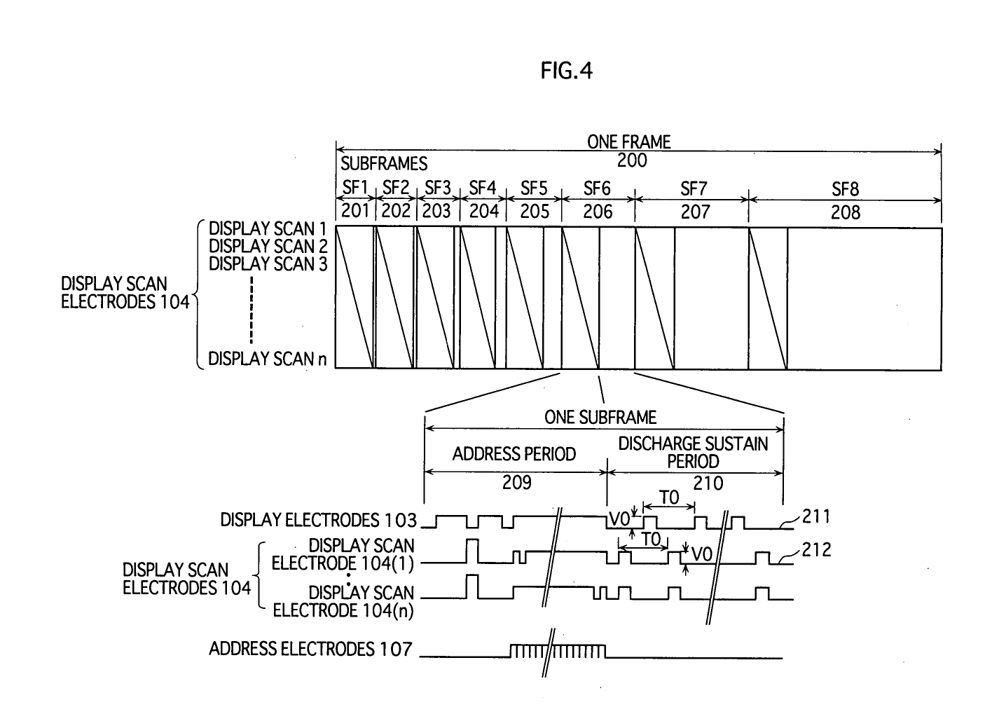

FIG. 4 shows an example of a method for dividing a frame 200 in a case where, for example, 256 levels of gray are to be expressed with use of “the intraframe time-division gray-scale display method”. The horizontal axis indicates time, and the parts shown with diagonal lines are address periods.

In the dividing method shown in the drawing, the frame 200 is divided into eight subframes 201 to 208. The number of the discharge sustain pulse in the subframes 201 to 208 are set so that the relative ratio between the luminances of the subframes 201 to 208 become 1:2:4:8:16:32:64:128. By controlling light-on and light-off of each of the subframes 201 to 208 according to the data concerning display luminances, it is possible to display 256 levels of gray with combinations of the eight subframes.

Each of the subframes 201 to 208 is made up of an address period 209 of a certain length, which is a common length for all the subframes, and a discharge sustain period 210 whose length varies in accordance with the relative ratio between the luminances.

In order to display an image in the image display cell field 1 (FIG. 2), the display scan electrodes 104 are scanned line by line from the first line to the n'th line during the address period 209, according to the subframe data Dsf, and micro-discharges are generated between the display scan electrodes 104 and the address electrodes 107, so that wall charges get accumulated in the discharge cells that need to emit light.

Subsequently, during the discharge sustain period 210, discharge sustain pulses 211 and 212 being rectangular waves of voltage V0 and cycle T0 are applied, being staggered from each other by half a cycle, to the display electrodes 103 and the display scan electrodes 104 in the whole area of the panel, all at the same time. This way, the discharges are sustained in the discharge cells in which a wall charge has been generated. Ultraviolet rays generated from these discharges cause the phosphor materials 110R, 110G, and 110B to get excited and emit light. By repeating this process for all the subframes 201 to 208, it is possible to selectively cause the cells that are orderly arranged to generate discharges and emit light according to the display data, and therefore display an image in the image display field 123 (FIG. 2) of the image display cell field 1.

Hereafter, the driving method for displaying normal images in the PDPs as above will be referred to as the “image display drive mode”.

(2) Driving Method of the Evaluation Cell Field 2

Secondly, explanation will be provided on a method of driving the evaluation cell field 2 that is used for life-span evaluations. Here, as for the evaluation cell field 2, it is acceptable to use the same driving method as the one used for displaying normal images in the image display cell field 1; however, using the method mentioned below, by which deterioration of the PDPs is accelerated, makes it possible to evaluate life spans of PDPs in a shorter period of time.

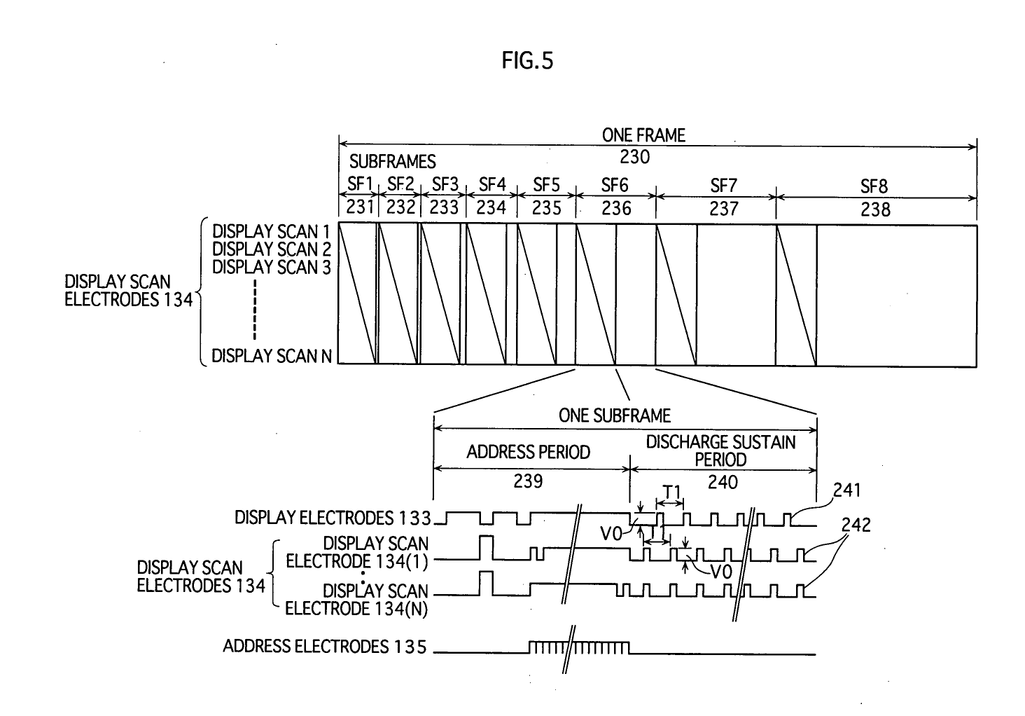

FIG. 5 shows the driving method of the PDP life test apparatus 150 in the first embodiment with an example of a method for dividing a frame. The horizontal axis indicates time, and the parts shown with diagonal lines are address periods.

The frame 230 is divided into eight subframes 231 to 238 to express 256 levels of gray. The discharge sustain pulse is set so that the relative ratio between the luminances of the subframes 231 to 238 become 1:2:4:8:16:32:64:128. Each of the subframes 231 to 238 is made up of an address period 239 and a discharge sustain period 240. As for these features, the structure and the length of the periods are the same as the image display drive mode explained with reference to FIG. 4, and therefore detailed explanation will be omitted.

What is different from the image display drive mode are discharge sustain pulses 241 and 242 that are applied to the display electrodes 133 and display scan electrodes 134 at the same time in the whole area of the panel, during the discharge sustain period 240.

The discharge sustain pulses 241 and 242 are rectangular waves of cycle T1 and voltage V0, and are applied being staggered from each other by half a cycle. The cycle T1 is set to be shorter than the cycle T0 (FIG. 4) of the discharge sustain pulses 211 and 212 at times of the image display drive mode using the image display cell field 1. Thus, the number of times of discharges during each of the discharge sustain periods 240 is larger than that in the image display drive mode. It also means that there are a larger number of times of discharges during the frame 230 as a whole than at times of the image display drive mode.

Generally speaking, when PDPs get closer to the end of their life spans, the following which are due to discharges in the discharges spaces can be observed: (1) decrease of luminance—caused by intensity decrease of ultraviolet rays, deterioration of phosphor materials, impurities being attached to the surface of the phosphor materials, and (2) malfunctions of discharge cells—caused by ion collisions with the cathode materials and changes in the electric field distribution due to sputtering with the cathode materials. Particularly, the biggest factors that shorten PDPs' life spans include deterioration of phosphor materials caused by ultraviolet rays generated at times of discharges as well as ion collisions with the cathode materials called sputtering which occurs at times of discharges. Consequently, by setting the cycle T1 of the discharge sustain pulses 241 and 242 shorter, and increasing the number of times of discharges in the frame 230 as a whole, it is possible to accelerate deterioration of phosphor materials by increasing the sputtering and the total amount of ultraviolet rays at times of discharges, and accordingly possible to accelerate deterioration of the evaluation cell field 2 in the PDP 130.

It has been learned through the research at this occasion that the speed of deterioration of the PDPs due to the increase in the number of times of discharges get accelerated in proportion to the total number of times of discharges in one frame at a time of image display drive mode. For example, if the number of times of discharges per frame to display at the maximum level in the gray-scale using the image display drive mode is set as 2560 times, which is ten times larger than 256 times, then the speed of deterioration of the PDP is accelerated in proportion to the number of times of discharges and the life span gets shortened by ten times.

Here, it is preferable to set the value of T1, i.e. the cycle of the discharge sustain pulse, as around 3 μsec to 10 μsec, in order to avoid panel cracks caused by heat due to the increase in the number of times of discharges.

In addition, since the address period is arranged in the same manner as under the normal operation conditions, it is possible to perform life tests reflecting the normal operation conditions where deterioration caused by address discharges is also taken into consideration.

Thus, it is possible to accelerate deterioration of PDPs at the evaluation cell field 2 reflecting the normal operation conditions, compared to at times of image display drive mode, and to evaluate the life span of the PDP 130 in a shorter period of time.

It should be noted that although the time length of the frame 230 has been explained to be equal to that of the frame 200 at times of image display drive mode, the time length of the frame 230 does not have to be equal. Even if the lengths of the frames are different, it is possible to achieve the same effects by setting the cycle T1 so that the number of times of discharges in the frame 230 per a certain period of time (i.e. the number of times of discharges divided by the time length of the frame 230) is more than the number of times of discharges in the frame 200 per a certain period of time (i.e. the number of times of discharges divided by the time length of the frame 200).

Furthermore, although it would not reflect the normal operation conditions, it is also possible to accelerate deterioration and perform a life span evaluation in a simplified form by generating at least one address discharge and then sustain discharge pulses sequentially.

Manufacturing Method of PDPs as Products

The following describes an example of the manufacturing method of the PDP 130 with reference to FIG. 3.

Formed on the front glass substrate 101 are the display electrodes 133 and the display scan electrodes 134 being disposed in parallel and in pairs. The display electrodes 133 and the display scan electrodes 134 are made up of (i) transparent electrodes and (ii) bus electrodes which are to prevent a voltage decrease caused by electrical resistance of the transparent electrodes (neither of the electrodes is shown in the drawing). The transparent electrodes are ITO layers deposited by the sputtering method, and the bus electrodes are printed Ag. The display electrodes 133 and the display scan electrodes 134 are covered with a printed dielectric layer 105, and are further covered with an MgO protective layer 106 deposited by EB evaporation. It is also acceptable if these electrodes are made up of only bus electrodes, without transparent electrodes.

Formed on the rear glass substrates 102 are address electrodes 135 disposed in stripes. The address electrodes 135 are printed Ag, and are covered with a printed dielectric layer 108. The electrodes 133, 134, and 135 are disposed with the same pitch as the electrodes 103, 104, and 107 in the image display cell field 1 are; therefore, each kind of electrodes disposed is in smaller quantity in proportion to the area size of the cell field. Along and between the address electrodes 135 are ribs 139 which are formed by, for example, a paste including glass materials that have repeatedly been screen-printed, and then baked. The ribs 139 divide the discharge space 143 into sub-pixels (areas of light-emitting units) in the direction of lines, and define the distance in-between as a fixed value (approximately 150 μm).

Here, on the front glass substrate 101 and the rear glass substrate 102 with the aforementioned members formed thereon, the constituents of the image display cell field 1 are formed concurrently in the same manner as the constituents of the evaluation cell field 2. The manufacturing method of the constituents of the glass substrates 101 and 102 is publicly known and disclosed for example in the Japanese Unexamined Patent Application Publication No. 2000-133143. Since the evaluation cell field 2 is formed concurrently on the same glass substrates 101 and 102 as the image display cell field 1 is formed, the costs for making the evaluation cell field 2 are only costs of the materials, which are much smaller than the cost of a PDP. Furthermore, the evaluation results of the life span characteristics of the evaluation cell field 2, which has been manufactured under the same condition, can be adopted as the evaluation for the life span characteristics of the image display cell field 1.

After the glass substrates 101 and 102 are combined opposing each other while keeping a distance therebetween to form discharge spaces 122 and 143 (FIG. 3), the cell fields 1 and 2 are respectively sealed all the way around by airtight sealing layers 121 and 141 made with frit glass.

Subsequently, the discharge spaces 122 and 143 are exhausted and filled with the aforementioned discharge gas. The image display cell field 1 and the evaluation cell field 2 may be filled with the discharge gas at the same time. Alternatively, it is acceptable to fill the evaluation cell field 2 with the discharge gas first to perform life tests, and then fill the image display cell field 1 later.

In the PDP 130 manufactured this way, the display electrodes 133 in the evaluation cell field 2 are electrically in common among themselves as shown in FIG. 1, and are connected with the display driver circuit 153 on one end of each line (on the right side in the drawing). The display scan electrodes 134, which are independent of each other, are connected with the display scan driver circuit 154 on the other end of each line (on the left side in the drawing). The ends of the address electrodes 135, which are independent of each other, are connected with the address driver circuit 155.

By applying voltages to the electrodes 133, 134, and 135 via the driver circuits 153, 154, and 155 with use of the driving method explained earlier with reference to FIG. 5, it is possible to deteriorate the evaluation cell field 2 and evaluate the life span from luminance deterioration and malfunctions of discharge cells and the like.

The evaluation can be made based on the results of inspection on certain items (e.g. the length of time till the luminance has deteriorated down to 50%, or if malfunctions of the cells has occurred). Plasma display panels that have been judged good will be treated as finish products, and those that have been judged bad will be treated as defective products and separated from the finish products. This way, it is possible to keep short-life plasma display panels from being distributed on the market.

As so far explained, the PDP 130 of the first embodiment comprises the image display cell field 1 and the evaluation cell field 2 to be used for life span evaluations on the same substrate. These cell fields 1 and 2 are formed being independent of each other with airtight sealing layers 121 and 141, and are driven independently by the electrodes provided respectively.

When evaluating the life span of the PDP 130, life span evaluations are made on the evaluation cell field 2; therefore, even if the cells in the evaluation cell field 2 are deteriorated or impurity gases are generated therein, the image display cell field 1 which is formed independently by the airtight sealing layer 121 can be used as a product. Thus, even if the number of PDP samples used in sample inspections of life tests increases, it is not necessary to dispose of those PDPs, and it is therefore possible to reduce the loss costs.

Further, it is possible to further shorten the time needed for life tests by using a driving method that accelerates deterioration or enclosing a gas that accelerates deterioration for the evaluation cell field 2.

By treating only PDPs with good results of life tests as finish products, it is possible to lower the possibilities of having short-life PDPs distributed on the market.

Additionally, it is desirable to position the evaluation cell field 2 as shown in FIG. 2; however, as long as the image display cell field 1 is exposed as a display screen and the evaluation cell field 2 is hidden when the PDP 130 is organized into a finish product such as a television, the evaluation cell field may be positioned anywhere, e.g. on the upper side, on the lower side, or around the image display cell field 1. Further, if a plurality of evaluation cell fields 2 are provided at positions that are not obstructive when the PDP 130 is organized into a television and the like, then life tests can be performed in more than one field and the reliability of the life tests will improve.

Furthermore, it is acceptable to have one evaluation cell field along with a plurality of image display cell fields on the substrates. This way, performing life tests in the evaluation cell field will work as life tests for two or more image display cell fields together, and the productivity will improve. When a PDP is manufactured this way, each of the image display cell fields can be cut out with a laser or the like. It is also possible to use one of the plurality of image display cell fields as a life span evaluation cell field.

Alternatively, it is possible to partition with an airtight sealing layer a part of the rectangular image display cell field 1 shown in FIG. 17, for example, a number of columns of discharge cells on the far right, and use them as an evaluation cell field 2. Moreover, since the discharge space 143, of the evaluation cell field 2 is provided being independent of the discharge space 122 of the image display cell field 1, it is also acceptable to remove the evaluation cell field 2 after life tests. Additionally, it is acceptable to provide a plurality of image display cell fields 1 on one set of glass substrates by using a front glass substrate 101 and a rear glass substrate 102 that are large enough for them. This way, it is possible to evaluate the life spans of the plurality of image display cell fields together utilizing the result of the life test for one evaluation cell field 2, and preferable cost-wise.

The electrodes 133, 134, and 135 are provided being independent of the electrodes 103, 104, and 107 in the image display cell field 1; however, it is also possible to arrange them to be electrically in common. In such a case, it is necessary to generate address discharges so that only the evaluation cell field 2 emits light during life tests.

Second Embodiment

The following describes the second embodiment of the PDP life test apparatus as an example to which the present invention is applied. The PDP life test apparatus 150 of the second embodiment has the same structure as the first embodiment except for the structure shown in FIG. 1 and the driving method of the evaluation cell field 2 shown in FIG. 5. Explanation on the same structures will be omitted.

The structure of the PDP life test apparatus 150 of the second embodiment is similar to the structure explained in the first embodiment with reference to FIG. 1 except for the method for storing image data into the frame memory 151 which will be explained as follows:

The image data DR, DG, and DB that have been stored in the frame memory 151 are read by the controller 152, and then converted into subframe data Dsf that indicates light-on or light-off of the cells for each color, before being stored in the frame memory 151 again. In the first embodiment, the frame memory 151 stores, for each frame, image data divided into subframes; however, here in the second embodiment, the frame memory 151 stores image data for just one subframe that is not divided. Consequently, the evaluation cell field 2 of the PDP 130 displays in 2 levels as to whether light-on or light-off of the cell.

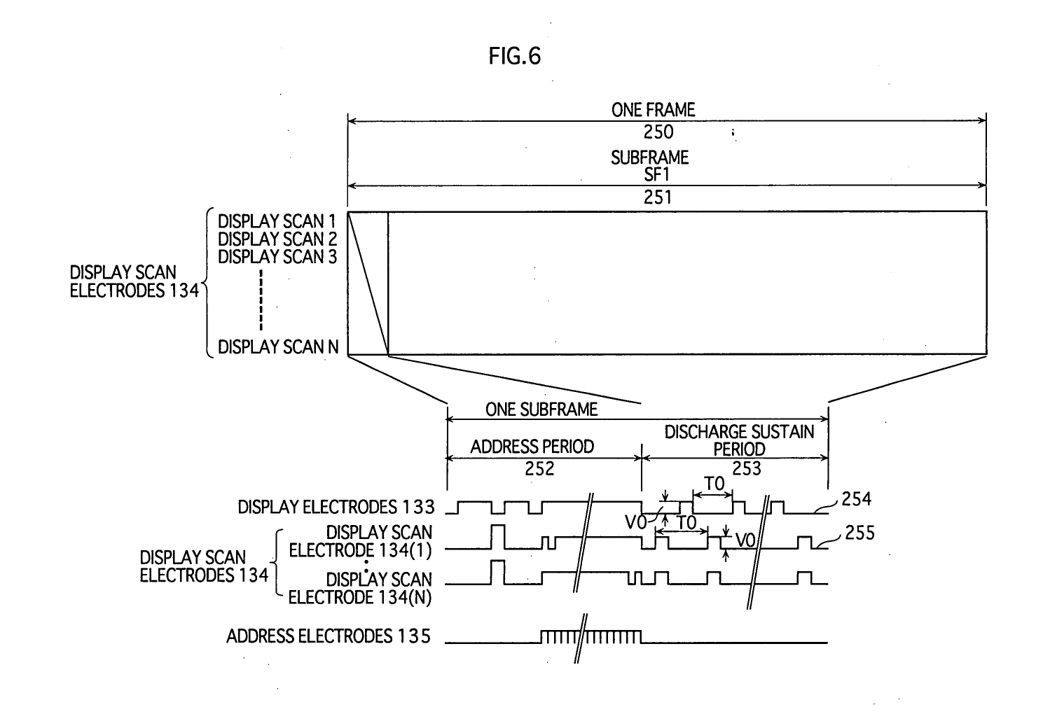

FIG. 6 shows the driving method of the PDP life test apparatus 150 in the second embodiment. The horizontal axis indicates time, and the part shown with a diagonal line is an address period.

The frame 250, being different from the frame 230 (FIG. 5) in the first embodiment, forms only one subframe 251 that is not divided into a plurality of subframes. The subframe 251 is made up of an address period 252 during which an address discharge is generated and a discharge sustain period 253 during which a sustain discharge is generated. Here, the frame 250 and the address period 252 have the same length as the frame 200 and the address period 209 in the image display drive mode respectively. The discharge sustain period 253 has the length that is the remainder of the subframe 251 besides the address period 252. Here, the discharge sustain pulses 254 and 255 applied to the display electrodes 133 and the display scan electrodes 134 are rectangular waves of voltage V0 and cycle T0, which are the same as in the image display drive mode.

With the structure mentioned above, it is possible to make the discharge sustain period 253 included in the frame 250 longer than in the case of the image display drive mode.

For example, when the image display driving method shown in FIG. 4 is used, by which 256 levels of gray cay be displayed, the number of times of address discharges in one frame 200 is eight, as one address discharge is generated for each of the subframes 201 to 208. On the other hand, when the driving method in the second embodiment shown in FIG. 6 is used, the number of times of address discharges in one frame 250 is only one, which is the address period 252 in the subframe 251.

It means that since the number of subframes is smaller than in the case of the image display drive mode, it is possible to make the address period 252 included in the frame 250 shorter than in the case of the image display drive mode; therefore, it is possible to assign a longer period of time to the discharge sustain period 253. Even if the discharge sustain pulse being applied has the same cycle T0 as in the image display drive mode, when the discharge sustain period 253 is longer, it is possible to make the number of times of discharges during one frame 250 larger than in the case of displaying at the maximum level in the gray-scale using the image display drive mode.

As mentioned before, the speed of deterioration of a PDP's life span gets accelerated in proportion to the number of times of discharges. According to the second embodiment, it is possible to evaluate life spans of PDPs under a condition close to the normal operation conditions, without omitting an address discharge, although the number of times of address discharges is reduced. The aforementioned driving method makes it possible to accelerate deterioration of the evaluation cell field 2 of PDPs more than in the case of the image display drive mode, while taking the normal operation conditions into consideration, and to evaluate life spans in a shorter period of time.

In addition, in the second embodiment, since the frame 250 forms one subframe 251 without being divided, high definition images cannot be expressed; however even when the frame is divided into a plurality of subframes so that high definition images can be displayed, as long as the number of subframes is smaller than that in the image display drive mode, it is possible to shorten the address periods 252 per frame 250 as much, and to make the discharge sustain period longer; Thus, it is possible to accelerate deterioration of PDPs.

Third Embodiment

The following describes the third embodiment of the PDP driving method as an example to which the present invention is applied. The PDP life test apparatus 150 of the third embodiment has the same structure as the ones explained with reference to FIGS. 2, 3 and 4, except that (i) the image data DR, DG and DB shown in FIG. 1 explained in the first embodiment make a display using the whole area of the panel sometimes, and make a display using a partial rectangular area sometimes, and (ii) the driving method of the evaluation cell field 2 shown in FIG. 5 is different. Explanation on the same structures will be omitted.

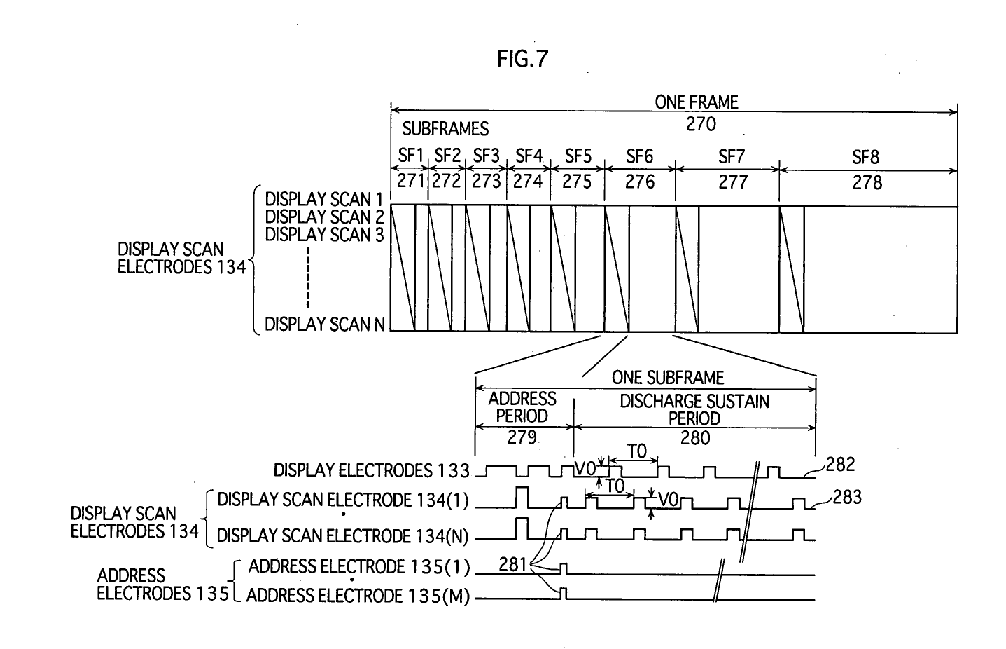

FIG. 7 shows the driving method of the PDP life test apparatus 150 in the third embodiment. The horizontal axis indicates time, and the parts shown with diagonal lines are address periods.

The frame 270 is divided into eight subframes 271 to 278, for example. The frame 270 and the subframes 271 to 278 have the same lengths as the frame 200 and the subframes 201, to 208 in the image display drive mode shown in FIG. 4 respectively.

Each of the subframes 271 to 278 is made up of an address period 279 during which data is to be written, and a discharge sustain period 280 during which a sustain discharge is generated.

During the address period 279, an address discharge 281 is generated by applying a voltage, only one time and all at the same time to each of all the display scan electrodes 134 (1 to N) and the address electrodes 135 (1 to M). By generating the address discharge 281 once all at the same time, there are micro-discharges generated between the display scan electrodes 134 and the address electrodes 135, and thus wall charges are generated in the whole area of the panel in the evaluation cell field 2.

During the discharge sustain period 280, discharge sustain pulses 282 and 283 of voltage V0 and cycle T0, which are the same voltage and cycle as in the image display drive mode, are applied to the display electrodes 133 and the display scan electrodes 134, the pulses being staggered from each other by half a cycle. Then, the discharge gets sustained in each of the discharge cells where a wall charge has been generated during the address period 279, and a white image gets displayed in the whole area of the panel. Here, the light pattern of the image displayed on the panel is a rectangular in a fixed position, since the address discharge 281 is generated only once all at the same time.

During the address period 279, because the address discharge 281 is generated at the same time, it is possible to finish in one time the scanning which is to apply an address voltage to the display scan electrodes 134. This way, it is possible to make the address period 279 shorter as much than in the case of the image display drive mode. Here, the length of the discharge sustain period 280 is the remainder of each of the subframes 271 to 278 besides the address period 279 which is shorter. It means that the discharge sustain period 280 is longer than the discharge sustain period 210 in the image display drive mode.

Even if the discharge sustain pulses 282 and 283 being applied have the same cycle T0 as in the image display drive mode, it is possible to make the number of times of discharges per frame 270 larger than in the case of image display drive mode so long as the discharge sustain period 280 is longer, and it is possible to accelerate deterioration of PDPs as mentioned earlier, and to evaluate life spans in a shorter period of time.

Conventionally, wall charges are generated in the cells that are to emit light by scanning as many times as the number of pieces of the display scan electrodes 134; however, in this case, generating the address discharges 281 only once will do. Thus, with this method, address discharges themselves are simplified, but there are still address discharges generated, so it is possible to evaluate life spans of PDPs with the normal operation conditions taken into account.

In the third embodiment, the address discharges are generated once; however, it is also acceptable to generate address discharges at the same time on more than two pieces of display scan electrodes 134, and thus, make the number of times of scanning (less than N, where N is the number of pieces of display scan electrodes 134) smaller than that in the image display drive mode. Consequently, it is possible to make the address period 279 shorter than that in the image display drive mode, and make the discharge sustain period 280 longer as much; therefore, it is possible to accelerate deterioration of PDPs in the same way as earlier mentioned.

Fourth Embodiment

The following describes a PDP driving method of the fourth embodiment of the present invention. The PDP life test apparatus 150 of the fourth embodiment has the same structure as the first embodiment explained with reference to FIGS. 1, 2, 3, and 4, except for the driving method of the evaluation cell field 2 (FIG. 5). Explanation on the same structures will be omitted.

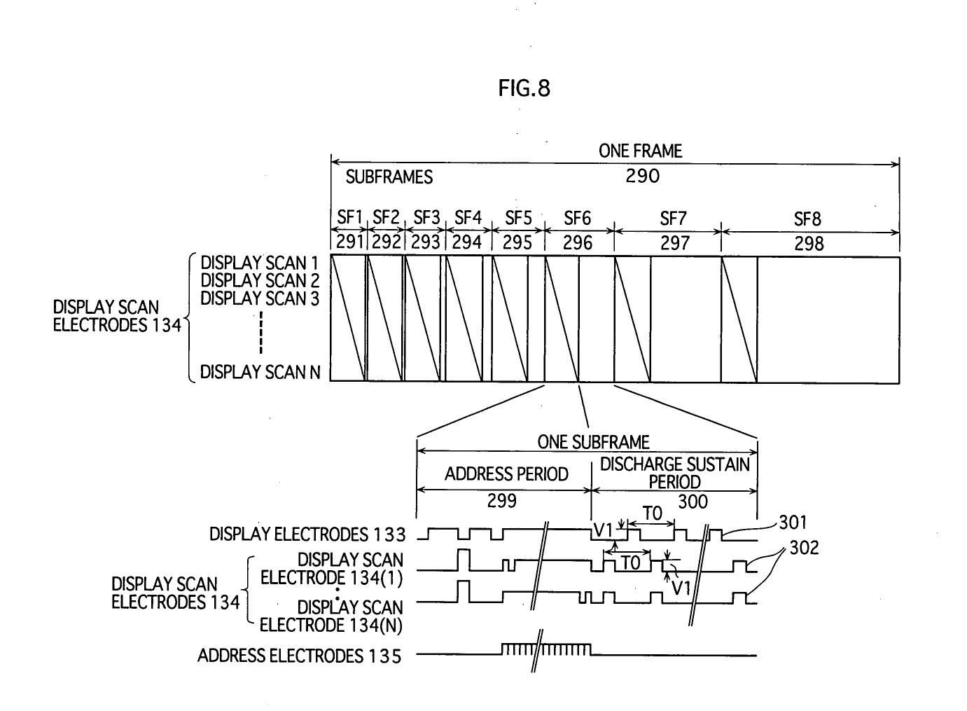

FIG. 8 shows the driving method of the PDP life test apparatus 150 in the fourth embodiment of the present invention. The horizontal axis indicates time, and the parts shown with diagonal lines are address periods.

The frame 290 is divided into eight subframes 291 to 298, for example. The frame 290 and the subframes 291 to 298 have the same lengths as the frame 200 and the subframes 201 to 208 in the image display drive mode shown in FIG. 4 respectively.

Each of the subframes 291 to 298 is made up of an address period 299 during which data is to be written, and a discharge sustain period 300 during which a sustain discharge is to be generated.

During the address period 299, in the same fashion as during the address period in the first embodiment, the display scan electrodes 134 are scanned line by line, according to the subframe data Dsf. Consequently, micro-discharges are generated between the display scan electrodes 134 and the address electrodes 135, and wall charges are accumulated in the discharge cells that are to emit light.

Subsequently, during the discharge sustain period 300, discharge sustain pulses 301 and 302, which are rectangular waves of voltage V1 and cycle T0, are applied to the display electrodes 133 and the display scan electrodes 134 in the whole area of the panel, being staggered from each other by half a cycle. This way, the discharges are sustained in the cells in which a wall charge has been generated. Consequently, discharges are repeatedly generated between the display electrodes 133 and the display scan electrodes 134 while the polarity of the voltage is reversed at every discharge.

Here, the voltage V1 of the discharge sustain pulses 301 and 302 is higher than the voltage V0 (normally, around 150 to 185 V) of the discharge sustain pulse at times of image display drive mode.

Because the voltage V1 is higher, the discharges generated during the discharge sustain period 300 is stronger than in the case of the image display drive mode, and phenomena such as ion collision with the cathode materials are accelerated; therefore, deterioration of phosphor materials is accelerated even if the number of times of discharges per a certain period of time is the same as in the image display drive mode (the cycle of the discharge sustain pulse is the same: T0). This way, it is possible to evaluate life spans of PDPs in a shorter period of time. In addition, since the address discharge is generated in the same way as in the image display drive mode, it is possible to evaluate life spans while taking deterioration of the address electrodes into consideration.

Here, it is preferable to make the voltage V1 of the discharge sustain pulses 301 and 302 high in view of the deterioration speed of the PDPs; however, if the voltage is too high, heat generation in the panel gets accelerated and there will be higher possibilities of having a panel crack; therefore, it is preferable to set the voltage around 150 to 250 V.

Fifth Embodiment

The following describes a PDP life test method and a PDP life test apparatus as examples to which the present invention is applied. The PDP life test apparatus 350 in the fifth embodiment is different from the PDP life test apparatus 150 (FIG. 1) explained in the first through fourth embodiments in that it comprises a signal generator 351. The PDP connected to the life test apparatus 350 is, for instance, the PDP 100 explained as a prior art (FIGS. 16 and 17).

General Structure of the PDP Life Test Apparatus 350

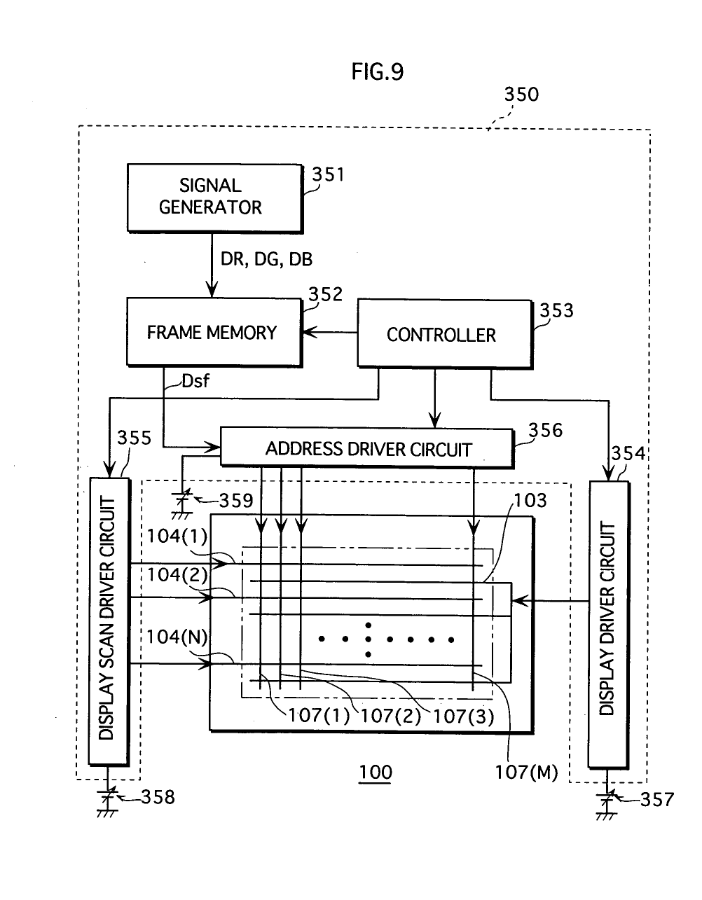

FIG. 9 is a circuit block diagram to show the structure of the PDP life test apparatus 350 of the fifth embodiment.

The PDP life test apparatus 350 is to be connected to, and to drive the PDP 100 in order to perform life tests. As shown in FIG. 9, the PDP life test apparatus 350 comprises the signal generator 351 that inputs image data DR (red), DG (green), and DB (blue) corresponding to light patterns used in the life tests; the frame memory 352 that stores image data DR, DG, and DB outputted from the signal generator 351; the controller 353 that controls the processing of inputs and outputs of the image data DR, DG, and DB, to and from the frame memory 352 as well as the driving of the circuits; the display driver circuit 354 that applies a discharge sustain voltage to the display electrodes 103 according to instructions from the controller 353; the display scan driver circuit 355 that applies a scanning address voltage and a discharge sustain voltage to the display scan electrodes 104; the address driver circuit 356 that applies a writing voltage to the address electrodes 107; and the power supplying units 357, 358, and 359 that each supply a voltage to the driver circuits 354, 355 and 356. The PDP life test apparatus 350 has the same structure as the PDP life test apparatus 150 explained with reference to FIG. 1 except that it comprises the signal generator 351. Explanation on the same structure will be omitted.

The signal generator 351 is a publicly-known programmable video signal generator that is operable to generate image signals corresponding to the light patterns desired. The signal generator 351 outputs, along with various synchronizing signals, multivalue image data DR, DG, and DB, indicating luminance levels (gray-scale levels) of red (R), green (G) and blue (B) in each pixel, to the frame memory 352 and the controller 353.

The frame memory 352 stores, for each frame, image data divided into subframes. The frame memory 352 once stores the image data DR, DG, and DB, that have been inputted from the signal generator 351. After being read from the frame memory 352 by the controller 353, the image data DR, DG, and DB are converted, for the purpose of display with gray-scale levels, to another kind of image data (hereafter referred to as subframe data, Dsf) which is a group of binary data indicating either light-on or light-off of the cells, for each subframe and for each color, before being stored back in the frame memory 352 again.

The controller 353 drives the display driver circuit 354, the display scan driver circuit 355, and the address driver circuit 356, using the driving method mentioned later, according to the subframe data Dsf.

By a method mentioned below, the PDP life test apparatus 350 will be used to perform life tests while images are displayed in the image display field 123 of the PDP 100. It should be noted that the method to be used to drive the PDP 100 is the intraframe time-division gray-scale display method which has been explained with reference to FIG. 4 in the first embodiment.

Light Patterns in the Image Display Field 123

The following explains the light patterns, which are unique to the present invention, to be displayed in the image display field 123 of the PDP 100, according to the image data transmitted from the signal generator 351.

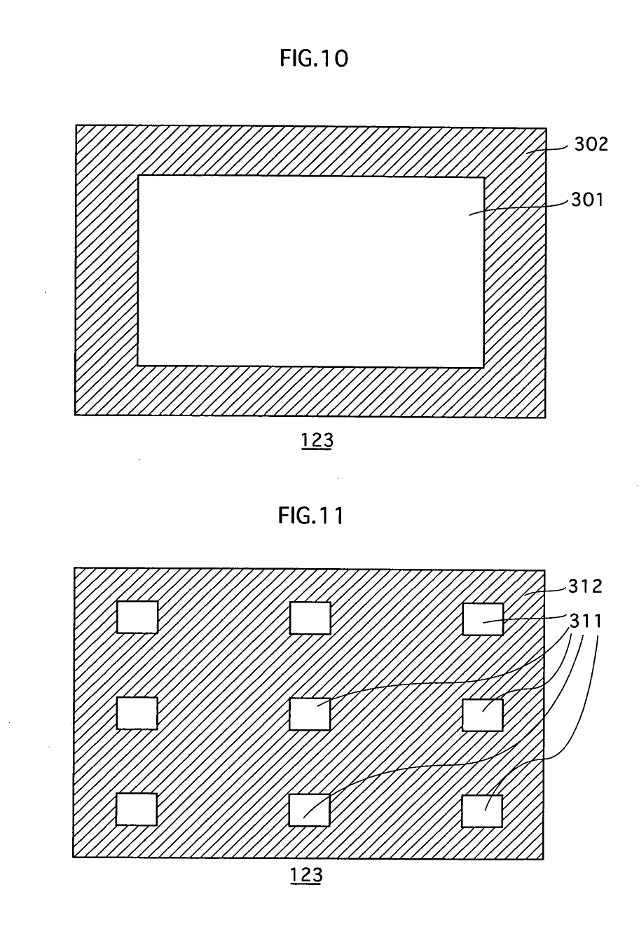

FIG. 10 shows a light pattern in the image display field 123 of the PDP 100.

As shown in FIG. 10, the image displayed in the image display field 123 is made up of an always-on area 301 and a blinking area 302.

The always-on area 301 is used for evaluating life spans, and has a white display shown during the life test, being positioned in a predetermined area except for the perimeter area of the image display field 123. As for images to be displayed in the always-on area 301, it would be preferable, in terms of deterioration of the life span of the PDP, to cause a set of cells having phosphor layers in the colors of R, G, and B to emit light continuously to make an all-white display (display at the maximum level in the gray-scale) so as to generate a large number of times of sustain discharges; however, it is also acceptable to lower the level in the gray-scale to some extent, or to display other arbitrary images.

The blinking area 302 is positioned in an area where it is not the always-on area 301 in the image display field 123. The blinking area 302 is an area where the lights blink by being turned off and on repeatedly. The lights blink with a cycle of 2 seconds, which means that the lights are on for a certain part of a two-second period, and off for the rest of the two-second period. Having the always-on area 301 and the blinking area 302 makes it possible to evaluate the life span by partially deteriorate the always-on area 301 so as to measure and detect deterioration of the luminance and changes in the discharge characteristics (malfunctions of the discharge cells). Additionally, the blinking area 302, which is positioned at the perimeter area of the image display field 123, gets cool while the lights are off; therefore, it is possible to mitigate stress concentration caused by thermal expansion of the glass substrates 101 and 102 in the vicinity of the airtight sealing layer 121 and to prevent panel cracks.

Generally speaking, some publicly-known organic substances get mixed into the phosphor layers 110R, 110G, and 110B at the manufacturing stage, and although most of the organic substances get eliminated in the baking process and so on, a very small quantity of the organic substances still remains as impurities. While the lights are on in the always-on area 301, the phosphor layers 110R, 110G, and 110B have a high temperature because of the heat generated during the sustain discharges and the sputtering, and the impurities in the phosphor layers get gasified and released. Also, it is assumed that the blinking area 302 has a high temperature, too, when the lights are on, and the impurities get gasified. The impurity gases deplete energy of the atoms of the inert gas inside the discharge space 122 and lower the luminance, or change the discharge characteristics and cause malfunctions of the discharge cells. Thus, the amount of impurity gases in the discharge space 122 has a big influence on the life span of the PDP 100.

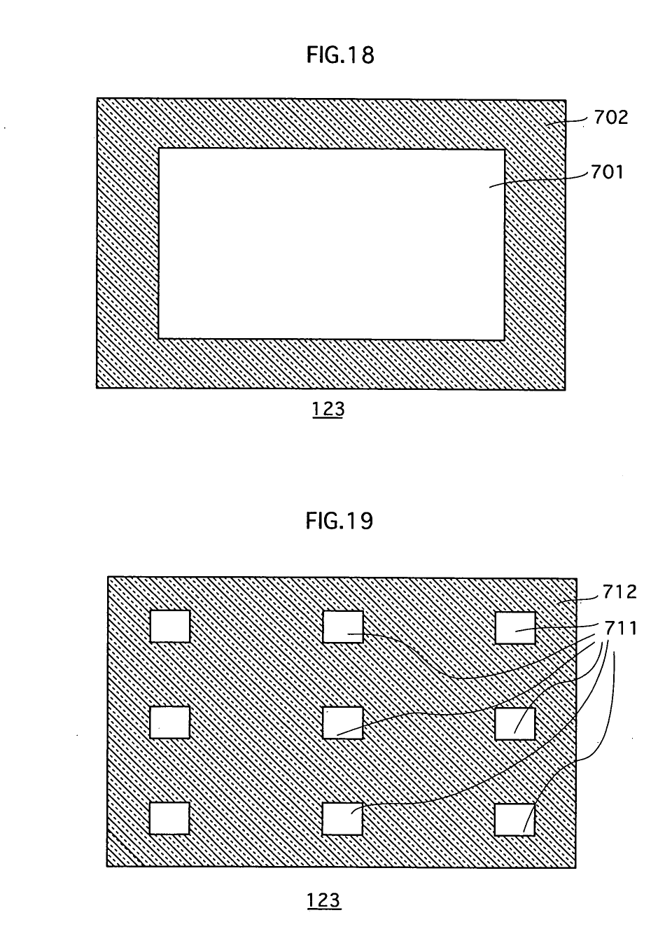

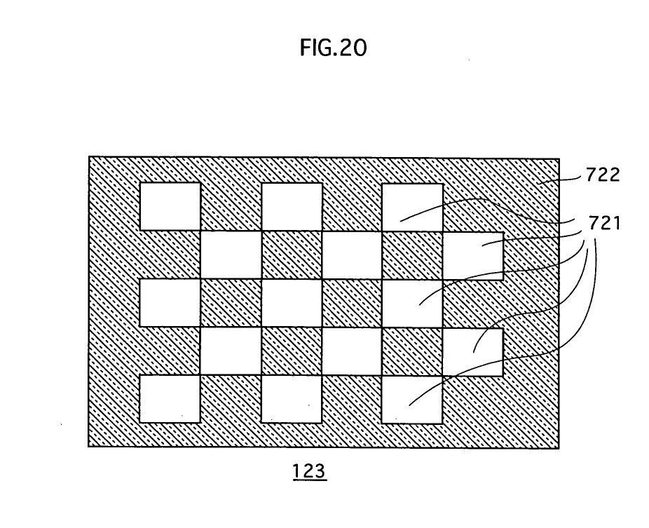

In life tests of the prior art, since an always-off area 702 is provided in the image display field 123 (both shown in FIG. 18), the impurity gases generated while the lights being turned on in the always-on area 701 (FIG. 18) get diffused, and then get trapped in the phosphor layers etc. in the always-off area 702. Because no lights are on in the always-off area 702 throughout the life test, the energy from discharges will not be added thereto. Thus, it is assumed that the impurities that have been trapped will get accumulated and will not be diffused to the outside of the area. Consequently, the impurity gas density inside the discharge space gradually decreases, and there are less possibilities that the impurity gases cause luminance deterioration and malfunctions of the discharge cells. On the other hand, under normal operation conditions, there is no always-off area; therefore, the impurity gas density inside the discharge space does not decrease like this. Thus, by life tests of the prior art, unlike under the normal operation conditions, it is difficult to perform a correct evaluation of life spans where the behavior of impurity gases is taken into consideration.

On the contrary, in the fifth embodiment, there is no always-off area, and sustain discharges are generated without exceptions in the whole area of the image display field 123. Also, even if impurity gases are trapped inside the phosphor layers 110R, 110G, and 110B in the blinking area 302, a large enough energy for gasification will be provided immediately because of the blinking, and the impurities will be released. Consequently, it is assumed the impurity gas density inside the discharge space 122 does not decrease unlike the prior art life test with an always-off area. This way, it is possible to evaluate life spans of PDPs under a condition similar to normal operations while taking the influence of impurity gases into consideration.

Here, the area size of the always-on area 301 needs to be at least as large as about ten cells for reasons related to the measuring device used in the life tests. Further, it is rather preferable if the area size is as large as under the normal operation conditions, especially when the life tests are aimed at evaluations of life spans under a condition similar to normal operations where the influence of the impurity gases inside the discharge space 122 (FIG. 17) is taken into consideration. If the area size is too big, there will be a problem of having panel cracks caused by the heat generated from sustain discharges; however, it is possible to alleviate this problem by improving heat dissipation from the panel using a fan to cool down the panel. Thus, it would be appropriate to determine the size of the always-on area 301 in view of heat generation and heat dissipation at the panels at times of life tests.

The blinking cycle of the blinking area 302 is not particularly limited, and may be determined in consideration of how much time is needed for cooling the heat generated during the sustain discharges. It is preferable if each continuous light-on period lasts at least ten percent of the blinking cycle. The reason for this is because it is assumed that when it is less than ten percent, there may not be enough number of times of discharges, and the temperature of the phosphor layers may not get high, and consequently the impurities trapped in the phosphor layers etc. may remain without being gasified.

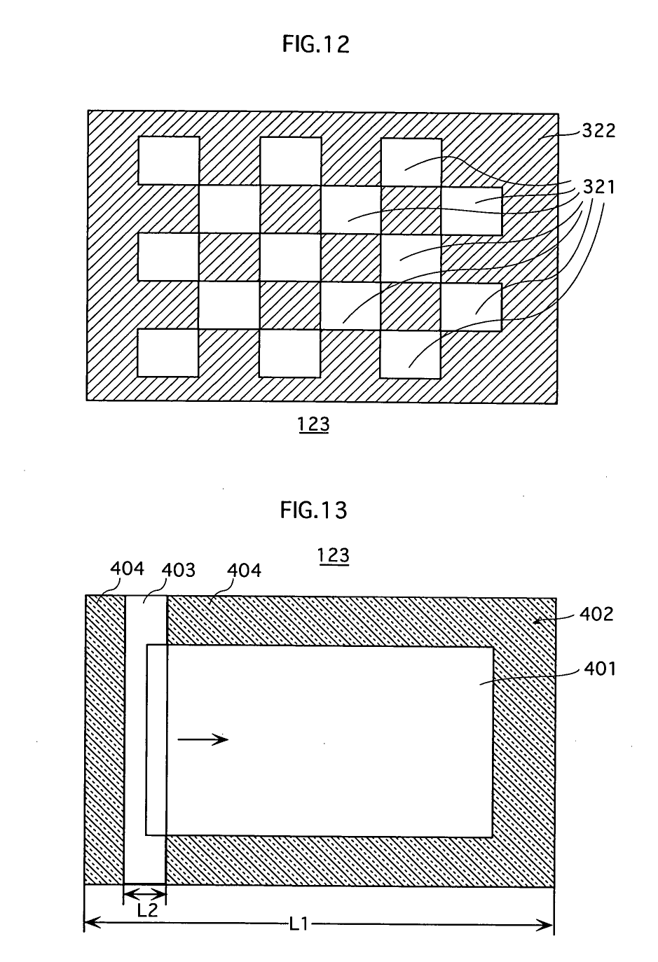

The position of the always-on area 301 is not limited to the pattern shown in FIG. 10 where it is positioned in the whole central area. It is also possible, for example, to have a plurality of always-on areas 311 positioned in a lattice pattern as shown in FIG. 11, or to have a plurality of always-on areas 321 and always-off areas 322 positioned in a checker pattern as shown in FIG. 12. Basically, it is acceptable if the always-on areas 311 and 321 are large enough for evaluation of life spans, and the blinking areas 312 and 322 are positioned in the whole perimeter area of the image display field 123, because this way it is possible to evaluate life spans of PDPs under a condition similar to the normal operations while preventing panel cracks.

As so far mentioned, when the light pattern in the image display field is made up of always-on areas and blinking areas, and the blinking areas are positioned in the substantially whole perimeter area of the image display field, it is possible to inhibit heat generation near the airtight sealing layer that could cause panel cracks, as well as to generate enough discharges in the blinking area for gasifying impurities trapped in the phosphor layers, and perform life tests under a condition similar to normal operations without lowering the impurity gas density inside the discharge space.

Sixth Embodiment

The following explains a PDP life test method and a PDP life test apparatus of the sixth embodiment of the present invention. The sixth embodiment is the same as the fifth embodiment except for the light pattern shown in FIG. 13. Explanation on the same structures such as the structure of the PDP life test apparatus will be omitted.

FIG. 13 shows a light pattern in the image display field 123 of the PDP 100 in the sixth embodiment of the present invention.

The image display field 123 is made up of an always-off area 401 and a blinking area 402.

Like the always-on area 301 that was explained with reference to FIG. 10 in the fifth embodiment, the always-on area 401 is rectangular and positioned at the central area of the image display field 123, and has a white display with the lights being turned on throughout the life test period. The life span of the PDP 100 is evaluated by accelerating deterioration in the always-on area 401 and measuring deterioration of the luminance and the changes in the discharge characteristics.

The blinking area 402 is positioned at the perimeter area of the image display field 123 so as to surround the always-on area 401.

In the sixth embodiment, the scroll-on area 403 which is a white display in the shape of a band having a fixed width of L2 keeps scrolling cyclically from the left end to the right end (in the drawing) of the image display field 123 while maintaining its shape. The lights in the blinking area 402 are off except when the scroll-on area 403 passes through. (In FIG. 13, the lights are off in the area 404 where the scroll-on area 403 does not exist.) This way, the blinking area 402 partially blinks periodically. The width L2 of the scroll-on area 403 (in the direction of the scrolling movement) is a certain percentage (at least 10 percent is preferable) of the length L1 which is the length of a side of the image display field 123 in the horizontal direction. The scroll cycle, in other words, how long it takes for the scroll-on area 403 to come back to the same place in one cycle, is set at 2 seconds. Thus, the discharge cells in the blinking area 402 make a white display in every cycle for a certain percentage of the scroll cycle period, and therefore, like in the fifth embodiment, the impurity gas density inside the discharge space does not decrease. Consequently, it is possible to correctly evaluate life spans of PDPs under a condition similar to normal operations with impurity gas density taken into consideration and to prevent panel cracks. Here the scroll cycle has been set at 2 seconds; however, it is acceptable if the scroll cycle is set in a range by which it is possible to prevent panel cracks in view of heat generation and heat dissipation in the blinking area 402.

In the sixth embodiment, the band scrolls from the left to the right as viewed facing the drawing; however, the direction is not limited to this, and the same effects are available even when the band scrolls in other directions such as from the right to the left, or from the top to the bottom, or in diagonal directions.

Seventh Embodiment

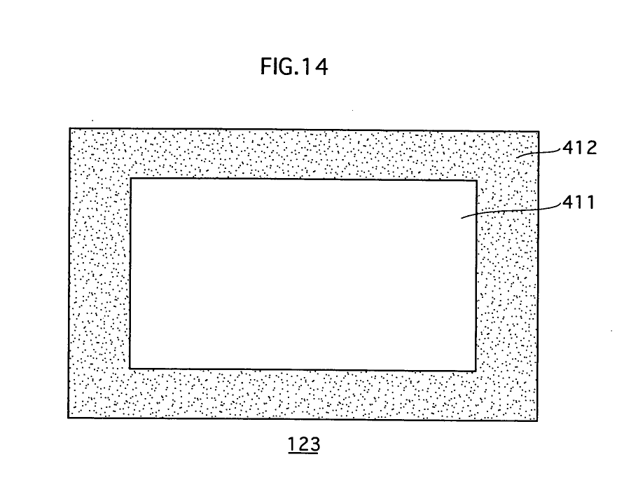

The following describes a PDP life test method and a PDP life test apparatus in the seventh embodiment of the present invention. The seventh embodiment is the same as the fifth embodiment except for the light pattern shown in FIG. 14. Explanation on the same structures such as the structures of the PDP life test apparatus will be omitted.

FIG. 14 shows a light pattern in the image display field 123 of the PDP in the seventh embodiment of the present invention.

As shown in the drawing, the image display field 123 is made up of a high gray-scale level area 411 and a low gray-scale level area 412, and differ from the image display field in the fifth and the six embodiments in that the whole area of the image display field 123 is continuously on.

Like the always-on area 301 in FIG. 10 of the fifth embodiment, the high gray-scale level area 411 is rectangular and positioned at the central area of the image display field 123, and has a white display during a life test, which means that all the colors of red, green, and blue are displayed at a high gray-scale level. The evaluation of life spans is performed by measuring deterioration of the luminance and changes in the discharge characteristics in the high gray-scale level area 411.

The low gray-scale level area 412 has a display at a certain gray-scale level that is lower than the high gray-scale level area 411. In other words, the low gray-scale level area 412 has a sustain discharge and emits light once a frame for sure, but there are one or more subframes during which a sustain discharge is not necessarily generated and no light is emitted. Thus, in the low gray-scale level area 412, the number of times of discharges per frame is smaller, and heat generation is inhibited as the display is at a low gray-scale level. The low gray-scale level area 412 is positioned at the perimeter area of the image display field 123 so as to surround the high gray-scale level area 411. The gray-scale level in the low gray-scale level 412 can be determined in a range where panel cracks are prevented in view of heat generation and heat dissipation.

Here, it is preferable to set the low gray-scale level to be at no less than one tenth of the maximum gray-scale level. For instance, as explained with reference to FIG. 4, if the panel is capable of expressing 256 levels of gray, then a sustain discharge preferably should be generated in the subframes 202, 204, and 205 during the frame 200 so as to display the 26^{th} level in the gray-scale. This way, in the low gray-scale level area 412, sustain discharges are generated for a predetermined percentage (at least 10%) of the time length of the total discharge sustain period.

Also in this embodiment, it is possible to avoid lowering the impurity gas density inside the discharge space and prevent panel cracks, with the same effects discussed in the fifth embodiment. Consequently, it is possible to correctly evaluate life spans of PDPs under a condition similar to normal operations with impurity gas density taken into consideration.

Additionally, it is also acceptable if the low gray-scale level area 412 is arranged so that the display has a gradation in which the gray scale level gets lower toward the perimeter area of the image display field.

In the fifth through seventh embodiments, the cycle of the discharge sustain pulse in the intraframe time-division gray-scale display method shown in FIG. 4 has been set at T0; however, it is also acceptable if the cycle is set at T1 which is shorter, so as to increase the number of times of discharges and accelerate the deterioration in order to shorten the time period needed for life tests. In such a case, even if the amount of heat generation increases inside the panel due to the increase of the number of times of discharges, it is possible to solve the problem of having panel cracks by adjusting the position and the area size of the always-on area (the high gray-scale level) in the panel, or, if necessary, by cooling the panel appropriately by way of water-cooling or air-cooling.

Additionally, in the sixth and the seventh embodiments, the always-on area 401 and the high gray-scale level area 411 are positioned at the central area of the image display field 123 as shown in FIGS. 13 and 14; however, it is possible to position them like the always-on areas 311 and 321 in FIGS. 11 and 12 and also replace the remaining areas with a blinking area or a low gray-scale level area. As long as the blinking area or the low gray-scale level area is positioned at the perimeter area of the image display area, it is possible, as mentioned earlier, to prevent panel cracks and perform life tests of PDPs under a condition similar to normal operations with the influence of impurity gases taken into consideration.

Eighth Embodiment

In the first embodiment, the evaluation cell field 2 is used for evaluating the life span of the PDP; however, it is also possible to use the evaluation cell field 2 for speculating an optimal time length of an aging period for the image display cell field 1.

The following explains a PDP aging test method in the eighth embodiment of the present invention. In the eighth embodiment, the PDP 130 and the life test apparatus 150 which are the same as in the first embodiment are used, and the structures are the same as in the first embodiment except that the life test apparatus 150 is used for the purpose of aging tests of the evaluation cell field 2. Explanation on the same structures will be omitted.

Normally, PDPs go through an aging process of a certain length of time before being shipped as products. The aging process is to have the whole area of a PDP emit light and keep doing it till the light emission is stabilized, in order to eliminate impurity gas molecules that have been absorbed in the panel. In other words, the discharge characteristics and the light emitting characteristics of the phosphor materials of the PDPs are stabilized through the process of separating impurity gas molecules with use of plasmas generated at times of light emissions in the PDPs, and taking the impurity gas molecules out to an area where there is no influence of the plasmas.

There are variations even in PDPs that have been manufactured in the same manufacturing process due to errors that occur during the process. An optimal length of the aging period is different from panel to panel, and the aging period tends to be either too long or too short for each panel. Thus, it is necessary to calculate an optimal length of the aging period for each panel.

In the eighth embodiment, the relativity of the aging period for the evaluation cell field 2 to the aging period for the image display cell field 1 is calculated in advance, and, for each PDP, an optimal aging period for the image display cell field 1 will be calculated using the aging period for the evaluation cell field 2 that has been measured.

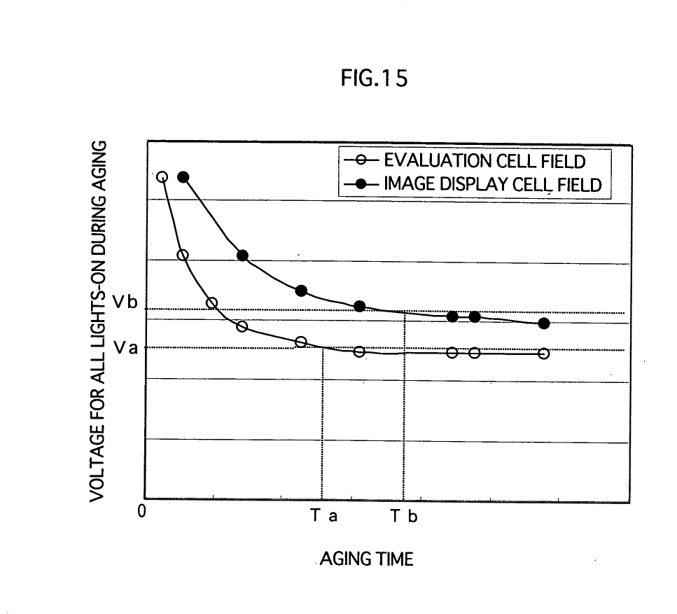

FIG. 15 is a graph that shows the correlation between the voltages to have all the lights on during the aging period and the aging time for the evaluation cell field 2 and image display cell field 1 of the PDP 130. “The voltage to have all lights on during aging” denotes a minimum voltage that is to be applied to the display electrodes and display scan electrodes when all the cells emit light in each of the cell fields 1 and 2.

As shown in the drawing, the voltage to have all the lights on (hereafter referred to as the light-on voltage) during the aging period in the evaluation cell field 2 decreases as the aging time elapses, and eventually gets stabilized at the level of Va after Time Ta. It means that the optimal length of the aging period for the evaluation cell field 2 is Time Ta, at which point the light-on voltage starts to be stabilized.

The light-on voltage in the image display cell field 1 also decreases as the aging time elapses, and eventually gets stabilized at the level of Vb after Time Tb. The optimal length of the aging period for the image display cell field 1 is Time Tb.

In this case, the optimal lengths of the aging period are found to be as Ta<Tb, and the light-on voltages are found to be as Va<Vb from which it is understood that the aging characteristics of the cell fields 1 and 2 are not identical even if they are in the same panel. The reason for this is that the aging characteristics are different for each cell even under a same aging condition, because there is a difference in the ultimate pressures between the discharge spaces as well as a difference in the sizes of the areas where there is no influence of the plasmas (near and inside the edges of the display field), due to the fact that the cell fields 1 and 2 have different area sizes for discharge spaces.

Here, the following formula can be derived from the correlation between Time Ta and Time Tb:

Ta=α×Tb \mathring{1}

By this formula \mathring{1}, the coefficient a which indicates the relativity between the cell fields 1 and 2 can be calculated. Once the coefficient a that indicates the relativity between the evaluation cell field 2 and the image display cell field 1 has been calculated this way, then measuring an optimal length of the aging period of the evaluation cell field 2 for each panel and dividing it by a is all you need to do to find out the optimal length of the aging period for the image display cell field 1.

This way, it is possible to speculate the optimal length of the aging period for the image display cell field 1 which could be different from panel to panel, by measuring the optimal length of the aging period for the evaluation cell field 2; therefore, it is possible to solve the problem in the prior art of having too long or too short an aging period.

It should be noted that the speculation of the optimal length of the aging period is made by measuring the light-on voltage; however, it does not have to be the light-on voltage. It is also acceptable if the speculation of the optimal length of the aging period is made based on measurement of the luminance of the blue phosphor material, whose luminance is easiest to be deteriorated, with respect to the aging time.

Modifications of the Embodiments

The first through fourth embodiments do not necessarily have to be embodied independently; by combining different methods of accelerating deterioration of PDPs discussed in these embodiments, it is possible to accelerate deterioration of luminance and occurrence of malfunctions of discharge cells due to discharge characteristics changes, both of which show life spans of PDPs. Further, in the first through fourth embodiments, there are possible concerns about panel cracks that could be caused by heat generation inside the panel and about pressure resistance against increase of electric current value, because the number of the discharge pulse and the voltage of the discharge sustain pulse increase; however, it is possible to embody the invention without problems by selecting the locations of light-on areas in the panel with address selection and adjusting the area sizes of the light-on areas, or appropriately cooling down the panels by water-cooling or air-cooling. Moreover, in the first through fourth embodiments, as an image to display on the screen, a white display that is fixed and continuously has the lights on is preferred because this way a set of cells having phosphor materials in the colors of red, green, and blue emit light continuously; however, it is also acceptable to display other arbitrary images, except for the third embodiment. Also, in each of the embodiments, a frame may be divided into a different number of subframes depending on the gray-scale level desired.

In the fifth through seventh embodiments, as for the discharge sustain pulses in the intraframe time-division gray-scale display method shown in FIG. 4, the cycle is set at T0, and the voltage is set at V0; however, it is also possible to shorten the period of time needed for life tests by accelerating deterioration by combining different ways of accelerating deterioration such as shortening the pulse cycle and increasing the voltage that were discussed in the first through fourth embodiments. In such a case, there are possible concerns that heat generation in the panel increases due to the increase of the number of times of discharges; however, it is possible to avoid having panel cracks by adjusting the locations and the area sizes of the always-on areas (high gray-scale level area) in the panel, or, if necessary, appropriately cooling down the panels by water-cooling or air-cooling.

In addition, in the fifth through seventh embodiments, life tests are performed using the normal intraframe time-division gray-scale display method; however, the invention is not limited to this, and it is also acceptable to provide an image display cell field and an evaluation cell field on a set of glass substrates like in the first through fourth embodiments, and perform life tests by applying a driving method to accelerate deterioration to one of these cell fields. This way, it is possible to perform life tests of PDPs under a condition similar to normal operations while preventing panel cracks.

Further, in the sixth and the seventh embodiments, the always-on area 401 and the high gray-scale level area 411 are positioned at the central area of the image display field 123 as shown in FIGS. 13 and 14; however, there is no problem if the always-on areas 311 and 321 shown in FIGS. 11 and 12 are replaced with the always-on area 401 or the high gray-scale level area 411, and the remaining blinking areas 312 and 322 are replaced with the blinking area 402 or the low gray-scale level area 412. As long as the blinking area 402 or the low gray-scale level area 412 are positioned in the perimeter area of the image display field, it is possible to prevent panel cracks, as mentioned earlier, and perform life tests of PDPs under a condition similar to normal operations with the influence of impurity gases taken into consideration.

### INDUSTRIAL APPLICABILITY

The plasma display panels of the present invention are particularly effective in a situation where cost reduction of the display panels is in demand.

1. A plasma display panel comprising:
a first cell field that includes discharge cells arranged in a matrix and is for image display; and
a second cell field that is provided in an area different from the first cell field, includes discharge cells arranged in a matrix, and is for performance evaluation.

2. The plasma display panel of claim 1, wherein
the first cell field and the second cell field both include electrodes to which such a voltage is applied that enables all the discharge cells in the cell fields to emit light, and
the first cell field and the second cell field are disposed inside discharge spaces that are independent of each other and sealed airtight.

3. The plasma display panel of claim 2, wherein
the electrodes in the first cell field are driven independently of the electrodes in the second cell field.

4. The plasma display panel of claim 2 or claim 3, wherein
discharge gas that is inert gas is enclosed in both of the discharge spaces, and
the discharge space of the second cell field further has additional discharge gas enclosed therein that accelerates deterioration of the discharge cells in the second cell field.

5. The plasma display panel of claim 4, wherein
the discharge gas enclosed in the discharge space of the second cell field has a smaller mean molecular weight than the discharge gas enclosed in the discharge space of the first cell field.

6. The plasma display panel of claim 4 or claim 5, wherein
the discharge gas enclosed in the discharge space of the second cell field is lower in pressure than the discharge gas enclosed in the discharge space of the first cell field.

7. A life test method for a plasma display panel comprising:
a first step of assembling the plasma display panel having (i) a first cell field that includes discharge cells arranged in a matrix and is for image display, and (ii) a second cell field that is provided in an area different from the first cell field, includes discharge cells arranged in a matrix, and is for evaluation of life span characteristics; and
a second step of evaluating the life span characteristics by driving the second cell field using a predetermined driving method.

8. The life test method of claim 7, wherein
the predetermined driving method accelerates deterioration of the second cell field more than a driving method used to display images in the first cell field does.

9. A manufacturing method of a plasma display panel comprising:
a first step of assembling the plasma display panel having (i) a first cell field that includes discharge cells arranged in a matrix and is for image display, and (ii) a second cell field that is provided in an area different from the first cell field, includes discharge cells arranged in a matrix, and is for evaluation of an optimal length of an aging process period;
a second step of evaluating the optimal length of the aging process period by driving the second cell field using a predetermined driving method; and
a third step of subjecting the first cell field to an aging process according to the optimal length of the aging process period evaluated for the second cell field.

10. A life test method for a plasma display panel by which deterioration of the plasma display panel is accelerated, wherein
the deterioration is accelerated while the plasma display panel is driven with use of an intraframe time-division gray-scale display method, and
according to the intraframe time-division gray-scale display method used in the life test method, a time-division display pattern is made so that (i) a frame includes one or more address periods during each of which an address discharge is generated, (ii) a remainder of the frame besides the address periods includes one or more discharge sustain periods, and (iii) a total number of discharges during the one or more discharge sustain periods per frame is larger than that in another intraframe time-division gray-scale display method that is used for normal operations of plasma display panels.

11. The life test method of the plasma display panel of claim 10, wherein
according to the intraframe time-division gray-scale display method used in the life test method, during at least one of the discharge sustain periods, a cycle of a discharge sustain pulse is shorter than that in the other intraframe time-division gray-scale display method that is used for normal operations of plasma display panels.

12. The life test method of the plasma display panel of claim 11, wherein
according to the intraframe time-division gray-scale display method used in the life test method, a total length of the address periods per frame is shorter than that in the other intraframe time-division gray-scale display method that is used for normal operations of plasma display panels.

13. The life test method of the plasma display panel of claim 12, wherein
according to the intraframe time-division gray-scale display method used in the life test method, a total number of the address periods per frame is smaller than that in the other intraframe time-division gray-scale display method that is used for normal operations of plasma display panels.

14. The life test method of the plasma display panel of claim 12 or 13, wherein
according to the intraframe time-division gray-scale display method used in the life test method, the address discharges are generated concurrently on two or more electrodes among electrodes disposed on the plasma display panel.

15. A life test method for a plasma display panel by which deterioration of the plasma display panel is accelerated, wherein
the deterioration is accelerated while the plasma display panel is driven with use of an intraframe time-division gray-scale display method, and
according to the intraframe time-division gray-scale display method used in the life test method, a time-division display pattern is made so that (i) a frame includes one or more address periods during each of which an address discharge is generated, (ii) a remainder of the frame besides the address periods includes one or more discharge sustain periods, and (iii) during at least one of the discharge sustain periods, a discharge sustain pulse is applied at a higher voltage level than in another intraframe time-division gray-scale display method that is used for normal operations of plasma display panels.

16. A life test apparatus for a plasma display panel comprising:
a display driving unit operable to drive the plasma display panel to display images;
a controlling unit operable to control the display driving unit so that (i) the plasma display panel is driven with use of an intraframe time-division gray-scale display method, and (ii) according to the intraframe time-division gray-scale display method used in the life test method, a time-division display pattern is made so that (a) a frame includes one or more address periods during each of which an address discharge is generated, (b) a remainder of the frame besides the address periods includes one or more discharge sustain periods, and (c) a total number of discharges during the one or more discharge sustain periods per frame is larger than that in another intraframe time-division gray-scale display method that is used for normal operations of plasma display panels.

17. A life test method of a plasma display panel, wherein
the plasma display panel is driven with use of an intraframe time-division gray-scale display method,
an always-on image, in which lights are continuously on, is displayed in an image display field of the plasma display panel except for a perimeter area that is near and inside edges of the image display field, and
a blinking image, in which lights are repeatedly turned off and on, is displayed in the perimeter area.

18. The life test method of the plasma display panel of claim 17, wherein
the blinking image is an image in which an area where lights are on cyclically scrolls in a predetermined direction, the area being in a shape of a band and having a predetermined width.

19. The life test method of the plasma display panel of claim 17 or claim 18, wherein
in the blinking image, the lights in the band-shaped area are on for at least ten percent of a time length of one cycle of blinking.

20. A life test method for a plasma display panel, wherein
the plasma display panel is driven with use of an intraframe time-division gray-scale display method,
a high gray-scale level image, in which light is emitted at a high gray-scale level, is displayed in an image display field of the plasma display panel except for a perimeter area that is near and inside edges of the image display field, and
a low gray-scale level image, in which light is emitted at a low gray-scale level, is displayed in the perimeter area.

21. A life test apparatus for a plasma display panel that includes a signal generating unit and performs a life test by driving the plasma display panel to display an image according to a signal generated by the signal generating unit, wherein
the signal generating unit generates (i) a signal to have the plasma display panel display an always-on image, in which lights are continuously on, in an image display field except for a perimeter area that is near and inside edges of the image display field, and (ii) a signal to have the plasma display panel display a blinking image, in which lights are repeatedly turned off and on, in the perimeter area.
